(19) United States
(12) Patent Application Publication
(10) Pub. No.: US 2023/0218001 A1
(43) Pub. Date: Jul. 13, 2023

(54) ATOMIZATION DEVICE

(71) Applicant: SHO Products, LLC, Torrance, CA (US)

(72) Inventors: Samuel Jurist, Chester, NJ (US); John Quion, Glendale, CA (US); JianFang Li, Zhongshan (CN); ChunLan Zhu, Zhongshan (CN)

(21) Appl. No.: 18/094,094

(22) Filed: Jan. 6, 2023

(30) Foreign Application Priority Data
Jan. 10, 2022 (CN) 202210024149.8
Jun. 9, 2022 (CN) 20221440285.7

(51) Int. Cl. A24F 40/46; H05B 3/06; G05D 23/24; A24F 40/53

(52) U.S. Cl. CPC A24F 40/46; H05B 3/06; G05D 23/2401; A24F 40/53; H05B 2203/007; H05B 2203/016

(57) ABSTRACT

A three-dimensional heating atomization device includes a shell, a heating element, a first thermo-electrode lead and a second thermo-electrode lead, wherein a heating chamber is arranged in the shell, one end of the first thermo-electrode lead is connected with one end of the heating element, and one end of the second thermo-electrode lead is connected with the other end of the heating element, so that a bottom surface and a side surface of the heating chamber are both heated by one heating member, and three-dimensional heating is more uniform and efficient, thus being beneficial for improving an atomization effect. Moreover, the first thermo-electrode lead and the second thermo-electrode lead not only can be used for supplying electric energy to the heating element to heat the heating chamber, but also can form a thermocouple by using the first thermo-electrode lead and the second thermo-electrode lead, so that a temperature of the heating element is detected by the thermocouple to realize a temperature control function of the heating element, thus avoiding use of a temperature measurement accessory such as a temperature sensor, simplifying an internal structure of an atomizer product, reducing accessories needed by the whole product, and allowing assembly and use to be more convenient and efficient.

### CROSS-REFERENCE TO RELATED APPLICATION(S)

This application claims priority to China Patent Application No. 202210024149.8, entitled “THREE-DIMENSIONAL HEATING ATOMIZATION DEVICE”, filed on Jan. 10, 2022, and China Patent application No: 20221440285.7, entitled “ATOMIZING DEVICE AND AROMATHERAPY DEVICE”, filed on Jun. 9, 2022, the contents of all of which are herein incorporated by reference in their entirety.

### TECHNICAL FIELD

The present disclosure generally relates to atomization and vaporizing devices, and more particularly, to an atomizer for improved heating and control of an electronic vaporizer.

### BACKGROUND

Generally, a vaporizer device mainly comprises a vaporizer body and an atomizer, wherein a chamber or bowl is arranged in the atomizer for placing organic materials. The organic materials may be atomized to generate atomized gas by heating the chamber or bowl. In order to uniformly heat the organic materials, an existing atomizer needs to arrange two sets of heating parts on a bottom surface and a side surface of the herb storage pot respectively, and also needs to arrange two sets of corresponding temperature sensors to respectively detect and control heating temperatures of the two sets of heating parts, thus having a complicated structure, numerous accessories, assembly inconvenience and a high cost.

When using an atomizing device, a user puts organic material into a heating bowl, and then the organic material may be atomized to generate vapor after heating. In order to realize a temperature control function, an existing atomizing device generally performs heating by a temperature control heating wire arranged on the heating bowl, and measures a heating temperature by a Temperature Coefficient of Resistance (TCR) technology. However, the temperature control heating wire must be electrified to heat up when the temperature is measured by the TCR, so that the user cannot know an actual temperature of the heating bowl when the temperature control heating wire does not heat up, thus being inconvenient to use.

Accordingly, there is a need for an improved atomization device or atomizer. There is a further need for an atomization device that provides improved heating. There is a need for an atomization device that provides heating on the walls and bottom of a heating bowl. There is an additional need for an improved atomization device that provides heating inside the walls and bottom of a heating bowl. There is a further need for an improved atomization device that is easier to manufacture, assemble, adjust, and maintain. The present invention satisfies these needs and provides other related advantages.

### SUMMARY

The present invention provides an improved atomization device or atomizer. The present invention provides an atomization device that provides improved heating. The present invention provides an atomization device that provides heating on the walls and bottom of a heating bowl. The present invention provides an improved atomization device that provides heating inside the walls and bottom of a heating bowl. The present invention provides an improved atomization device that is easier to manufacture, assemble, adjust, and maintain. The present invention satisfies these needs and provides other related advantages.

The present invention aims to solve at least one of the technical problems in the prior art. Therefore, the present invention provides a three-dimensional heating atomization device, which heats a bottom surface and a side surface of a herb storage pot at the same time by one heating element, so that heating is more uniform; and moreover, a first thermo-electrode lead and a second thermo-electrode lead may be used for power supply and temperature measurement of the heating element, thus having a simple structure and assembly convenience, and being beneficial for reducing a cost.

The present invention also aims to solve at least one of the technical problems in the prior art. Therefore, the present invention provides an atomizing device, wherein a heating temperature of the atomizing device may be measured more conveniently and controlled more flexibly by adding a temperature measuring structure. The present invention also provides various devices (including, without limitation, an aromatherapy device, a vaporizing device, or the like), which is convenient for a user to realize flexible heating, atomization and temperature control.

According to an embodiment of the present invention, an atomization device for three-dimensional heating is provided. The atomization device comprises a material chamber having a bottom surface and a sidewall surface; a heating element having a first segment configured to heat the bottom surface of the material chamber and a second segment configured to heat the sidewall surface of the material chamber; a first thermo-electrode lead, wherein a first end of the first thermo-electrode lead is connected to a first end of the heating element; a second thermo-electrode, wherein a first end of the second thermo-electrode lead is connected to a second end of the heating element; and a shell, the shell housing the material chamber, the heating element, the first thermo-electrode lead, and the second thermo-electrode lead.

According to a first aspect of the previous embodiment of the atomization device, the material chamber is thermally coupled to the heating element. According to a second aspect of the previous embodiment of the atomization device, the material chamber is removable.

According to another embodiment of the present invention, the atomization device further comprises a heating container arranged in the shell, the heating container having a bottom portion and a sidewall portion, wherein the sidewall portion extends from the bottom portion defining a heating cavity and an upper opening, and wherein the heating element is arranged on the bottom portion and the sidewall portion of the heating container. According to an aspect of the present invention, both the first end of the first thermo-electrode lead and the first end of the second thermo-electrode lead are arranged on the heating container. According to a further aspect of the present invention, the heating element, the first thermo-electrode lead, and the second thermo-electrode lead are integrated with the heating container.

According to another embodiment of the present invention, the atomization device further comprises a marking member, an identification module, and a control module, wherein the marking member is arranged in the shell, the identification module is connected with the marking member to collect electrical parameters of the marking member, and the control module is connected with the identification module to control operation of the heating element according to the electrical parameters. According to an aspect of the embodiment, the marking member is a resistor.

According to another embodiment of the present invention, the atomization device further comprises a power supply module and a temperature measurement module, wherein a second end of one of the first thermo-electrode lead or the second thermo-electrode lead is connected with the power supply module and a second end of one of the first thermo-electrode lead or the second thermo-electrode lead is connected with the temperature measurement module.

According to another embodiment of the present disclosure, the shell of the atomization device further comprises an air inlet communicated with an upper opening of the material chamber, wherein ambient air passing through the air inlet is directed towards a bottom surface of a heating cavity of the material chamber. In another aspect of the present embodiment, the shell further comprises an air inflow guide member, the air inflow guide member having a through hole forming the air inlet, and wherein one end of the air inflow guide member extends out to ambient air and the other end of the air inflow guide member extends into the material chamber.

According to another embodiment of the present invention, the shell further comprises a heat insulation assembly.

According to another embodiment of the present disclosure, a three-dimensional heating atomization device is provided. The three-dimensional atomization device comprises a shell; and a heating container assembly disposed within the shell. The heating container assembly includes a heating chamber having a bottom wall portion and a sidewall portion, the sidewall portion extending from the bottom wall portion defining an interior cavity and an upper opening; and a heating element disposed within the sidewall portion and the bottom wall portion of the heating chamber. According to one aspect, the heating container assembly further comprises a first thermo-electrode lead, a first end of the first thermo-electrode lead connected to a first end of the heating element; and a second thermo-electrode lead, a first end of the second thermo-electrode lead connected to a second end of the heating element. According to a further aspect, a heat distribution rate of the bottom wall portion of the heating element is greater than a heat distribution rate of the sidewall portion of the heating element.

According to another embodiment of the present disclosure, a vaporizer device including the three-dimensional heating atomization device is provided. The vaporizer device further comprises a base body housing a power supply, the base body having an identification portion to interface with the three-dimensional heating atomization device; and a mouthpiece removably attached to the base body.

According to another embodiment of the present disclosure, a three-dimensional heating atomization device is provided. The three-dimensional heating atomization device comprising a shell; and a heating container assembly disposed within the shell. The heating container assembly comprising a heating chamber having a bottom wall portion and a sidewall portion, the sidewall portion extending from the bottom wall portion defining an interior cavity and an upper opening; and a heating element having a first segment disposed within the sidewall portion of the heating chamber and a second segment disposed within the bottom wall portion of the heating chamber, wherein the first segment of the heating element has a different resistance than the second segment of the heating element. According to a first aspect, the first segment of the heating element has a lower resistance than the second segment of the heating element. According to another aspect, the heating container assembly further comprises a first thermo-electrode lead, a first end of the first thermo-electrode lead electro-mechanically connected to a first end of the heating element; and a second thermo-electrode lead, a first end of the second thermo-electrode lead electro-mechanically connected to a second end of the heating element.

According to another embodiment of the present disclosure, a vaporizer device including the previous embodiment of the three-dimensional heating atomization device is provided. The vaporizer further comprises a base body, the base body including a power supply and a connection port for the three-dimensional heating atomization device; and a mouthpiece removably attached to the base body.

The three-dimensional heating atomization device according to the embodiment of the present invention has at least the following beneficial effects.

According to the three-dimensional heating atomization device of the present invention, the bottom surface and the side surface of the herb storage pot are both heated by one heating element, and three-dimensional heating is more uniform and efficient, thus being beneficial for improving an atomization effect of organic materials. Moreover, the first thermo-electrode lead and the second thermo-electrode lead not only can be used for supplying electric energy to the heating element to heat the herb storage pot, but also can form a thermocouple by using the first thermo-electrode lead and the second thermo-electrode lead, so that a temperature of the heating element is detected by the thermocouple to realize a temperature control function of the heating element, thus avoiding use of a temperature measurement accessory such as a temperature sensor, simplifying an internal structure of an atomizer product, reducing accessories needed by the whole product, and allowing assembly and use of an atomizer to be more convenient and efficient.

According to some embodiments of the present invention, the three-dimensional heating atomization device further comprises a heating container arranged in the shell, wherein the heating container is provided with a heating cavity having an upper opening, the herb storage pot is located in the heating cavity, and the heating element is arranged on a bottom portion and a side wall of the heating container.

According to some embodiments of the present invention, one end of the first thermo-electrode lead connected with the heating element and one end of the second thermo-electrode lead connected with the heating element are both arranged on the heating container.

According to some embodiments of the present invention, the heating element, the first thermo-electrode lead and the second thermo-electrode lead are integrated with the heating container.

According to some embodiments of the present invention, the three-dimensional heating atomization device further comprises a marking member, an identification module and a control module, wherein the marking member is arranged in the shell, the identification module is connected with the marking member to collect electrical parameters of the marking member, and the control module is connected with the identification module to control operation of the heating element according to the electrical parameters.

According to some embodiments of the present invention, the marking member is a resistor.

According to some embodiments of the present invention, the three-dimensional heating atomization device further comprises a power supply module and a temperature measurement module, wherein the other end of the first thermo-electrode lead is connected with the power supply module and the temperature measurement module respectively, and the other end of the second thermo-electrode lead is connected with the power supply module and the temperature measurement module respectively.

According to some embodiments of the present invention, the shell is provided with an accommodating cavity, the herb storage pot is located in the accommodating cavity, the shell is provided with an air inlet communicated with the accommodating cavity, and an air flow passing through the air inlet is capable of being blown to an inner bottom portion of the herb storage pot.

According to some embodiments of the present invention, the shell is also provided with a hollow tubular air inflow guide member, the air inflow guide member is provided with a through hole forming the air inlet, one end of the air inflow guide member is located in the herb storage pot, and the other end of the air inflow guide member extends out of the accommodating cavity.

According to some embodiments of the present invention, the shell is also provided with a heat insulation assembly.

An atomizing device according to an embodiment of the present invention in a second aspect comprises: a shell, wherein a heating bowl is arranged in the shell; a thermosensitive heating assembly arranged on the heating bowl; and a temperature measuring structure arranged in the shell for measuring a temperature of the heating bowl.

The atomizing device according to the embodiment of the second aspect of the present invention at least has the following beneficial effects.

In the atomizing device of the second aspect of the present invention, the thermosensitive heating assembly arranged on the heating bowl is made of a thermosensitive heating resistance material, so that when the thermosensitive heating assembly is electrified, the thermosensitive heating assembly not only is capable of converting electric energy into heat energy to generate heat for heating the heating bowl, so as to atomize a material (e.g., an organic material) placed in the heating bowl to form vapor, but also is capable of judging a current heating temperature according to a resistance value of the thermosensitive heating assembly by a TCR technology, while in the case of stopping heating the thermosensitive heating assembly, an actual temperature of the heating bowl can be measured by the temperature measuring structure, so that a limitation of temperature measurement by the TCR is overcome by adding the temperature measuring structure, and a user can know a current heating temperature of the heating bowl in time whether the thermosensitive heating assembly is electrified to be heated or not, thus realizing more convenient measurement and more flexible control of a heating temperature of the atomizing device.

According to some embodiments of the second aspect of the present invention, the temperature measuring structure is a contact temperature measuring structure, and the contact temperature measuring structure is connected with the heating bowl.

According to some embodiments of the second aspect of the present invention, the contact temperature measuring structure comprises a thermocouple assembly arranged on the heating bowl.

According to some embodiments of the second aspect of the present invention, the thermocouple assembly comprises a first thermo-electrode lead wire and a second thermo-electrode lead wire arranged on the heating bowl, one end of the first thermo-electrode lead wire is connected with one end of the thermosensitive heating assembly, and one end of the second thermo-electrode lead wire is connected with the other end of the thermosensitive heating assembly.

According to some embodiments of the second aspect of the present invention, the thermosensitive heating assembly and the heating bowl are in an integrated structure.

According to some embodiments of the second aspect of the present invention, the heating bowl is provided with an accommodating cavity with an upper opening, and the thermosensitive heating assembly is arranged on a bottom portion and a side wall of the heating bowl.

According to some embodiments of the second aspect of the present invention, the thermosensitive heating assembly comprises a first heating element and a second heating element, the first heating element is arranged on the bottom portion of the heating bowl, and the second heating element is arranged on the side wall of the heating bowl.

According to some embodiments of the second aspect of the present invention, the heating bowl is made of a material comprising an inorganic nonmetallic material.

According to some embodiments of the present invention, the atomizing device further comprises a marking member, an identification module and a control module, wherein the marking member is arranged in the shell, the identification module is connected with the marking member to collect electrical parameters of the marking member, and the control module is connected with the identification module to control operation of the thermosensitive heating assembly according to the electrical parameters.

A vaporizer device according to an embodiment in a third aspect of the present invention comprises the atomizing device according to any one of the embodiments above.

The vaporizer device according to the embodiment of the third aspect of the present invention at least has the following beneficial effects.

In the vaporizer device of the third aspect of the present invention, the atomizing device may measure an actual heating temperature of the heating bowl when the thermosensitive heating assembly is electrified to be heated and stopped being electrified to be heated respectively by using the temperature measuring structure according to a resistance value of the thermosensitive heating assembly, so that a user may know a current heating temperature in time, thus being convenient for the user to realize flexible control of the heating atomization temperature.

This brief summary has been provided so that the nature of the invention may be understood quickly. Additional aspects and advantages of the present invention will be given in part in the following more detailed description, taken in conjunction with the accompanying drawings, which can become apparent from the following description, which illustrate, by way of example, the principles of the invention or be understood through practice of the present invention. Any drawings contained herein constitute a part of this specification and include exemplary embodiments of the present invention and illustrate various objects and features thereof.

### BRIEF DESCRIPTION OF THE DRAWINGS

The various present embodiments now will be discussed in detail with an emphasis on highlighting the advantageous features with reference to the drawings of various embodiments. The illustrated embodiments are intended to illustrate, but not to limit the invention. These drawings include the following figures, in which like numerals indicate like parts: The above and/or additional aspects and advantages of the present invention will be apparent and easily understood from the descriptions of the embodiments with reference to the following drawings, wherein:

FIG. 1 illustrates a schematic structural diagram of an atomization device according to an embodiment of the present disclosure;

FIG. 2 illustrates a cross-sectional view of the atomization device of FIG. 1;

FIG. 3 illustrates a schematic structural diagram of a heating element assembly according to an embodiment of the present disclosure;

FIG. 4 illustrates a cross-sectional view of the heating element assembly of FIG. 3;

FIG. 5 illustrates a perspective view of a schematic structural diagram of a vaporizer device according to an embodiment of the present disclosure;

FIG. 6 illustrates a locally enlarged view of circle A in FIG. 5;

FIG. 7 illustrates a schematic structural diagram of the vaporizer body assembled with an atomization device according to an embodiment of the present disclosure;

FIG. 8 illustrates a cross-sectional view of the vaporizer body assembled with the atomization device of FIG. 7;

FIG. 9 illustrates a locally enlarged view of circle B in FIG. 8;

FIG. 10 illustrates a cross-sectional view of an atomization device according to an embodiment of the present disclosure;

FIG. 11 illustrates a schematic structural diagram of a heating assembly of the atomization device of FIG. 10;

FIG. 12 illustrates a cross-sectional view of an atomization device according to an embodiment of the present disclosure;

FIG. 13 illustrates a perspective view of a schematic structural diagram of an atomization device according to an embodiment of the present invention;

FIG. 14 illustrates a side view of the atomization device of FIG. 10;

FIG. 15 illustrates an exploded view of the atomization device of FIG. 10;

FIG. 16 illustrates a perspective view of a schematic structural diagram of a heating container assembly according to an embodiment of the present disclosure;

FIG. 17 illustrates the heating container assembly of FIG. 16 in phantom to show a heating element contained therein according to an embodiment of the present disclosure;

FIG. 18 illustrates a perspective view of the heating element of FIG. 17;

FIG. 19 illustrates a cross-sectional view of the heating container assembly of FIG. 16; and

FIG. 20 illustrates a cross-sectional view of an atomization device according to an embodiment of the present disclosure.

### DETAILED DESCRIPTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved atomization device. The following detailed description describes the present embodiments, with reference to the accompanying drawings. In the drawings, reference numbers label elements of the present embodiments. These reference numbers are reproduced below in connection with the discussion of the corresponding drawing features. It is to be understood that the figures and descriptions of the present invention have been simplified to illustrate elements that are relevant for a clear understanding of the present invention, while eliminating, for the purpose of clarity, many other elements found in aromatherapy and vaporizing devices. Those of ordinary skill in the pertinent arts may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the pertinent arts.

Embodiments of the present invention are described in detail hereinafter, and illustrations of the embodiments are shown in the drawings, wherein identical or similar reference numerals denote identical or similar elements or elements having the same or similar functions. The embodiments described hereinafter with reference to the drawings are exemplary and only intended to explain the present invention, and cannot be understood as limiting the present invention.

In the description of the present invention, it should be understood that the orientation or position relationship indicated by the terms “up”, “down”, “front”, “rear”, “left”, “right”, “vertical”, “horizontal”, “top”, “bottom”, “inside”, “outside”, and the like is based on the orientation or position relationship shown in the accompanying drawings, it is only for the convenience of description of the present invention and simplification of the description, and it is not to indicate or imply that the indicated device or element must have a specific orientation, and be constructed and operated in a specific orientation. Therefore, the terms shall not be understood as limiting the present invention.

In the description of the present invention, several means one or more, a plurality of means more than two, greater than, less than, more than, and the like are understood as not including this number, while above, below, within, and the like are understood as including this number. If there are the descriptions of first and second, it is only for the purpose of distinguishing technical features, and should not be understood as indicating or implying relative importance, implicitly indicating the number of the indicated technical features or implicitly indicating the order of the indicated technical features.

In the description of the present invention, it should be noted that the terms “installation”, “connected” and “connection” if any shall be understood in a broad sense unless otherwise specified and defined. For example, they may be fixed connection, removable connection or integrated connection; may be mechanical connection or electrical connection; and may be direct connection, or indirect connection through an intermediate medium, and connection inside two elements. The specific meanings of the above terms in the present invention can be understood in a specific case by those of ordinary skills in the art.

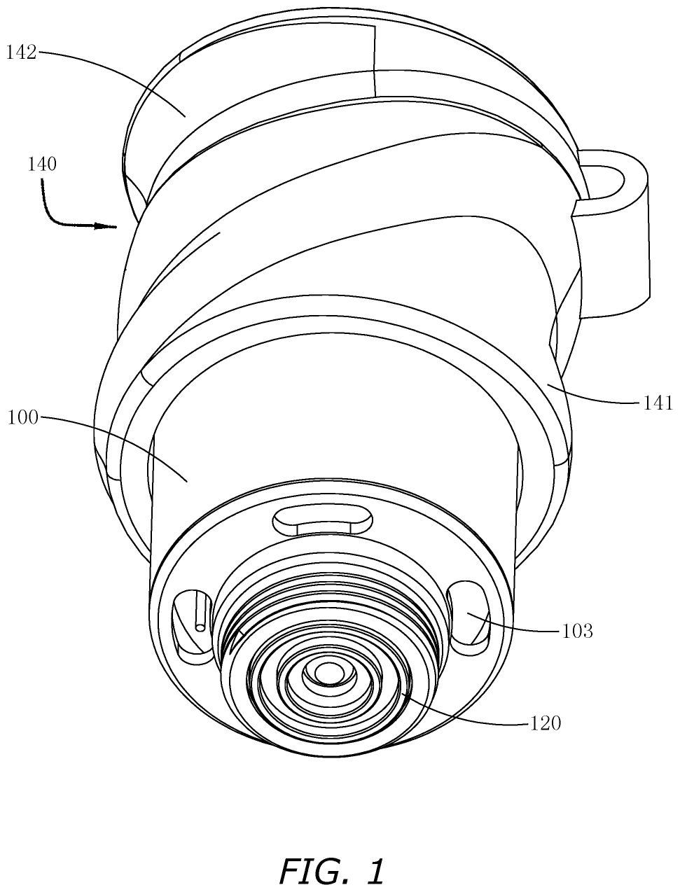

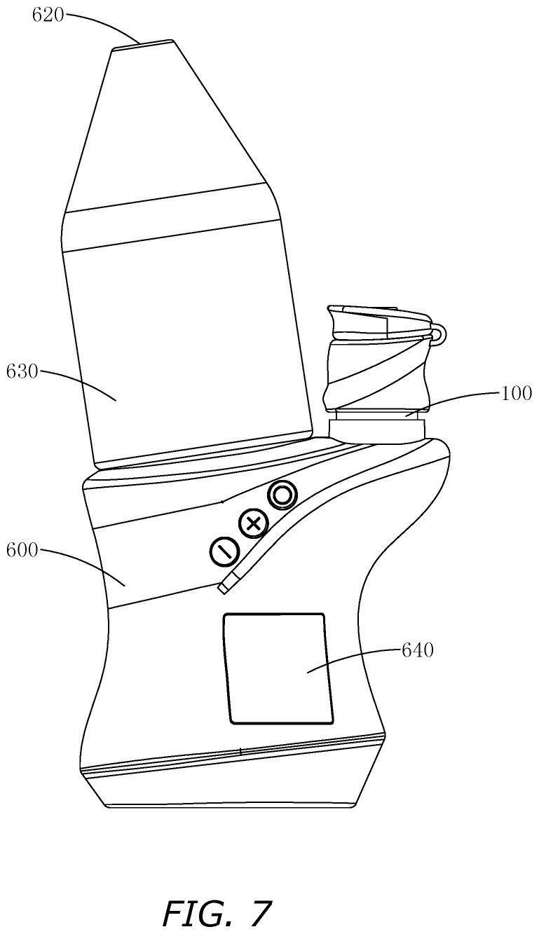

With reference to FIGS. 1-12, embodiments of the present invention provide for atomization devices and electric vaporizing devices having an atomization device. According to an embodiment of the present invention, an atomization device comprises a shell 100, a material chamber 110, and a heating element 200. According to embodiments, the atomization device further comprises a first and a second thermo-electrode lead 310, 320 or a thermocouple assembly 410 including a first thermo-electrode lead 411 and a second thermo-electrode lead 412.

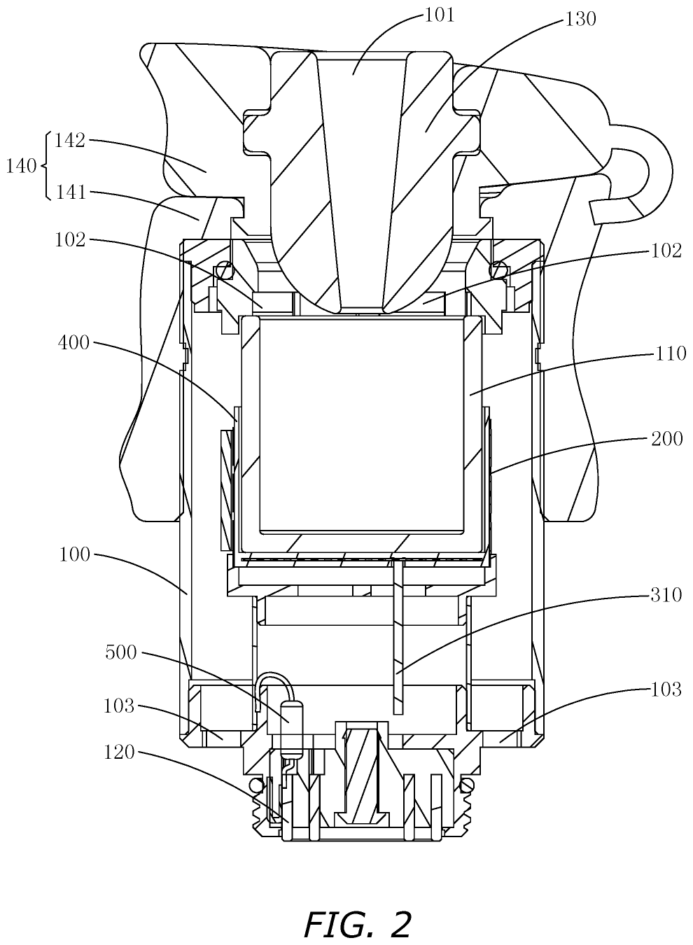

FIGS. 1-2 show a perspective view and a cross-sectional view, respectively, of an atomization device according to embodiments of the present invention. FIG. 1 depicts the outer body of the atomization device showing a shell 100, an electric conduction portion 120, a plurality of air outlets 103, and a heat insulation assembly 140. The heat insulation assembly 140 may include a silica gel sleeve 141, and a removable silica cap 142. The shell 100 may have different shapes and sizes. The sleeve and cap of the heat insulation assembly may be made of silicone or similar material. According to an embodiment shown in FIG. 2, the atomization device comprises a shell 100, a heating element 200, and a first thermo-electrode lead 310 and a second thermo-electrode lead 320. A material chamber 110 is arranged inside the shell 100. In one aspect, the material chamber 110 is removable. In another aspect, the material chamber 110 is integrated with the heating element 200 within the shell. The shell may be composed of plastics, metals, or silicone. The material chamber 110 has at least a bottom wall portion and a sidewall portion extending out from the bottom wall portion wherein the bottom wall and sidewalls provide an inner cavity and an upper opening. The user may insert organic materials into the material chamber 110 via the upper opening into the inner cavity for atomization of said organic materials.

Various organic materials may be placed within the material chamber 110 including, but not limited to, plant material (e.g., botanicals, medicinal herbs, cannabis, etc.), oil (e.g., botanical oils, cannabis oils, etc.), aromatherapy material (e.g. essential oils, botanical oils, etc.) and the like. With further respect to organic materials including cannabis materials, these may include but are not limited to: natural herb such as cannabis flower, bud, or kief, as well as hemp; concentrates such as kief, shatter, oil, wax, powder, or rosin; etc. It should be understood that specific chemical compounds of, for purpose of example, cannabis, may be stored or atomized in varying forms having various benefits and limitations, thus the need for atomization devices that provide a variety of temperatures and heat distribution may be dependent upon the intended use for a specific organic material as well as the final substance type such material is concentrated within. For other organic materials, for example aromatherapy materials, the material type may benefit from different solutions including oils, or waxes, and thus the heating elements and heating distribution may be dependent upon the same. Furthermore, atomization of materials meant for inhalation as compared to materials intended for dispersion in ambient air require different heating elements with respect to temperature levels and heat distribution.

Referring to FIG. 2, the heating element 200 is arranged in the shell 100, and the heating element 200 is used for heating a bottom surface and a sidewall surface of the material chamber 110. The first thermo-electrode lead 310 and the second thermo-electrode lead 320 (not shown in FIG. 2) are arranged in the shell 100, one end of the first thermo-electrode lead 310 is connected with one end of the heating element 200, and one end of the second thermo-electrode lead 320 is connected with the other end of the heating element 200. The heating element 200, for example, may be a resistance wire(s), a heating sheet, a combination of resistance wire(s) and a heating sheet, etc.

A user may add organic materials into the material chamber 110 for atomization wherein the bottom surface and the sidewall surface of the material chamber 110 may be heated by only one heating element 200, so that the material chamber 110 may be subjected to three-dimensional heating providing for uniform heat distribution within the inner cavity of the material chamber 110. Compared with single-side heating, the application of three-dimensional heating is more uniform and efficient, thus being beneficial for improving an atomization effect of the organic materials within the material chamber 110. The improved uniform heat distribution within the material chamber has multiple advantages including improved vapor quantity or volume yield, as well as quality of atomized materials leading to improved flavor or taste. In particular, three-dimensional heating improves efficiency via increased surface area of heating within the material chamber. In addition, by providing improved temperature control of the material chamber via three-dimensional heating, the temperature gradient within the material chamber is reduced allowing for said improved uniform temperature distribution. Furthermore, in addition to the shape of the material chamber, the improved uniform heat distribution reduces the occurrence of hot spots and cold spots within the material chamber. Hot spots may lead to overheating of organic materials, which may break down active compounds of the organic materials, while cold spots cause organic materials to gunk up within the material chamber increasing cleaning needs and efficiency of the device. The improved uniform heat distribution of the atomizer more closely resembles the experience and performance level of a non-electronic rig or device.

The first thermo-electrode lead 310 and the second thermo-electrode lead 320 may be made of conductor or semiconductor materials, however, the material used for making the first thermo-electrode lead 310 and the second thermo-electrode lead 320 are dissimilar, for example, the first thermo-electrode lead 310 and the second thermo-electrode lead 320 may be made of nickel chromium and nickel silicon, respectively. Since one end of each of the first thermo-electrode lead 310 and the second thermo-electrode lead 320 are both connected with the heating element 200, electric energy may be supplied to the heating element 200 for heating by electric conduction through the first thermo-electrode lead 310 and the second thermo-electrode lead 320, while the other ends of the first thermo-electrode lead 310 and the second thermo-electrode lead 320 are connected with a detection instrument, and the two ends of the first thermo-electrode lead 310 and the second thermo-electrode lead 320 are combined into a loop to form a thermocouple. It should be noted that since a temperature of the heating element 200 after heating is high, an electromotive force may be generated in the loop according to a thermoelectric effect, the purpose of temperature measurement may be achieved by measuring a thermo-electromotive force and converting the same, and according to a third conductor law of the thermocouple (described above), a third conductor is connected into the loop of the thermocouple. Introduction of the third conductor has no influence on a total electromotive force of the loop of the thermocouple as long as temperatures at two ends of the third conductor are the same. Specifically, the heating element 200 is equivalent to the third conductor, so that temperature detection of the heating element 200 may be realized by using one ends of the first thermo-electrode lead 310 and the second thermo-electrode lead 320 connected with the heating element 200 as thermal ends, thus realizing a temperature control function on the heating element 200. Meanwhile, use of a temperature measurement accessory such as a temperature sensor is avoided, so that an internal structure of an atomizer product is simplified, and accessories needed by the whole product are reduced, thus allowing assembly and use of the atomizer to be more convenient and efficient.

Referring to FIGS. 2-4, the atomization device further comprises a heating container 400 arranged in the shell 100 according to some embodiments of the present disclosure. The heating container 400 is provided with a heating cavity having an upper opening, the material chamber 110 is located in the heating cavity, and the heating element 200 is arranged on a bottom portion and a sidewall portion of the heating container 400.

Specifically, with reference to FIGS. 2-4, the heating container 400 may be a bowl- or pot-like shape and made of metal (e.g. stainless steel, titanium, etc.), wherein the metal conducts heat quickly and is not easy to crack. In the alternative, the heating container 400 may be made of a ceramic or glass material. The resistance wire or the heating sheet is arranged on a bottom portion and a sidewall portion of the heating container 400, forming a three-dimensional heating cavity within the heating container 400. The material chamber 110 is placed in the heating cavity to realize the three-dimensional heating atomization of the organic materials and improved affects thereof as described above. Moreover, the material chamber 110 may also be removeable and thus taken out of the heating cavity of the heating container 400, thus being convenient for cleaning and replacement. In another aspect, the material chamber 110 is integrated with the heating container 400 and/or heating element 200 within the shell.

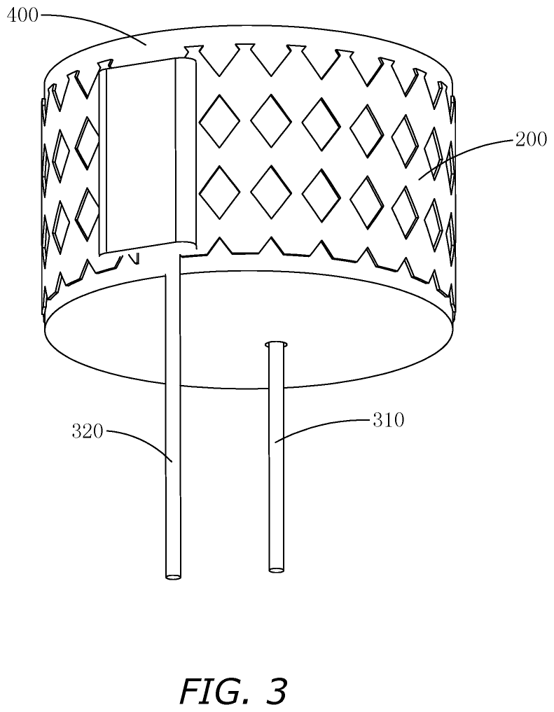

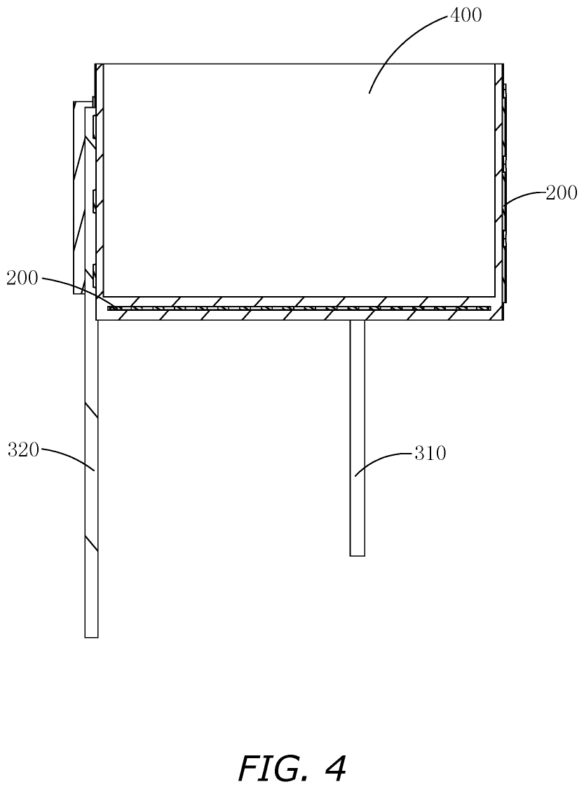

In some embodiments of the present invention, as shown in FIGS. 3-4, both of the one end of the first thermo-electrode lead 310 connected with the heating element 200 and the one end of the second thermo-electrode lead 320 connected with the heating element 200, are arranged on the heating container 400.

Specifically, with reference to FIGS. 3-4, for example, one end of the first thermo-electrode lead 310 connected with the heating element 200 is arranged on the bottom portion of the heating container 400, and one end of the second thermo-electrode lead 320 connected with the heating element 200 is arranged on the sidewall portion of the heating container 400. It should be noted that the one end of the first thermo-electrode lead 310 connected with the heating element 200 and the one end of the second thermo-electrode lead 320 connected with the heating element 200 are both used as the thermal ends of the thermocouple for temperature measurement. The thermal ends of the thermocouple are arranged on the heating container 400, so that a temperature detected by the thermocouple is a temperature at the heating container 400 and the material chamber 110, which means that the temperature detected by the thermocouple is an actual heating temperature of the organic materials, and is not just a heating temperature of the heating element 200, thus realizing more accurate temperature control heating of the organic materials, and being beneficial for improving the atomization effect of the organic materials.

In some embodiments of the present invention, as shown in FIGS. 3-4, the heating element 200, the first thermo-electrode lead 310 and the second thermo-electrode lead 320 are integrated with the heating container 400.

It can be understood that assembly of a heating structure may be avoided in later assembly of the atomizer product by designing a heating part of the atomizer into an integrated structure, which is beneficial for improving an assembly efficiency. Moreover, the integrated heating structure may also be tested separately in advance before assembly, thus avoiding problems of the heating part that can only be found during detection of finished products after assembly, thus being beneficial for improving a yield and a quality control effect.

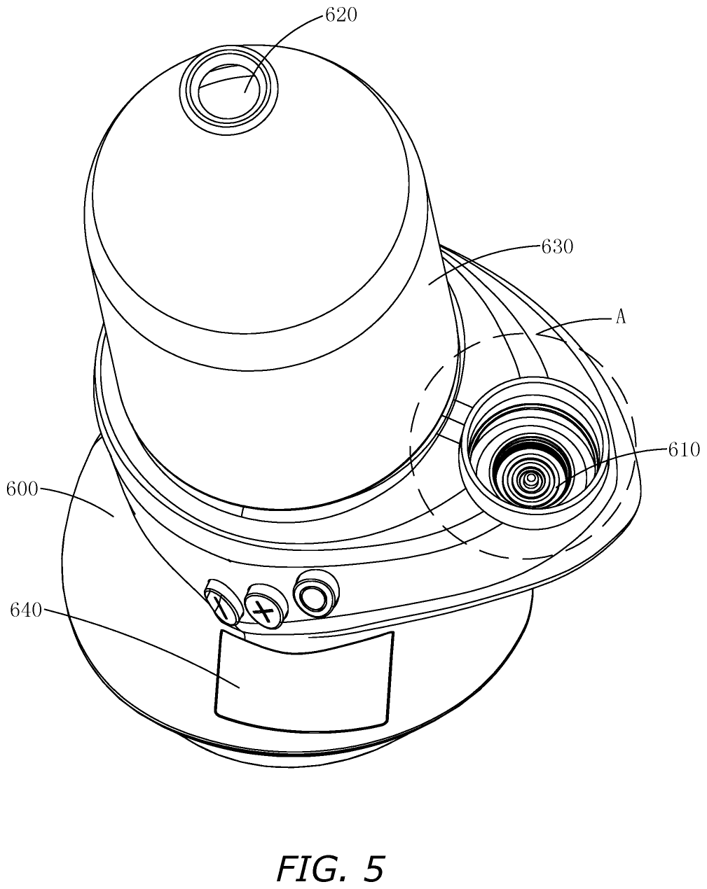

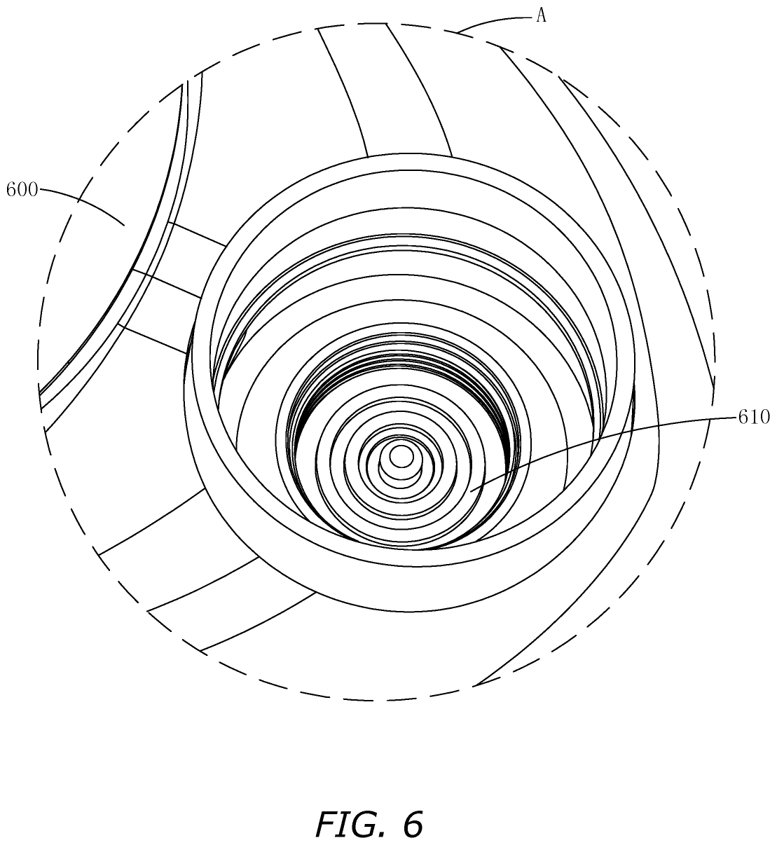

Referring to FIG. 5, a vaporizer device is provided according to an embodiment of the present disclosure. The vaporizer device comprises a base body 600, a filter assembly 630 having a suction nozzle 620, and an identification portion 610 for interfacing with an atomization device (not shown). The filter assembly 630 and atomization device may be removably attached to the base body 600 and is generally made from a glass material including ceramic, zirconia, etc. The base body may house the power supply and various modules (as described below) and include a display screen 640 and user input button(s). As shown in FIGS. 5-6, the base body 600 has an identification portion 610 for connecting an atomization device. The identification portion 610 may be comprised of metals including stainless steel, brass, etc.

In some embodiments of the present invention, the vaporizer device further comprises a marking member 500 (located on the atomization device), an identification module and a control module (control module refers to the motherboard or main circuit such as a CPU, MCU, etc.). The identification module interfaces with the marking member 500, the identification portion 610 and the electric conductive portion 120. The working principle is that the identification portion 610 recognizes the resistance of the marking member 500 through the electric conduction portion 120 and then transmits the identification of that resistance back to the base body 600, where the base body 600 then corresponds to different atomizer heating modes according to the specific resistance value of marking member 500. The marking member 500 is a resistor.

The marking member 500 is arranged in the shell 100, the identification module is connected with the marking member 500 to collect electrical parameters of the marking member 500, and the control module is connected with the identification module to control operation of the heating element 200 according to the electrical parameters.

The marking member 500 may be an electronic component such as a resistor or a potentiometer, with different electrical parameters. The identification module may be a circuit module or a chip, and configured for collecting the specific electrical parameters of the marking member 500. The control module may be a central processing unit (CPU) or composed of a microcontroller unit (MCU) and a peripheral circuit thereof. Generally, the identification module and the control module may both be arranged on a base body 600 of a vaporizer, and the marking member 500 arranged in each atomization device is different, for example, a plurality of different atomization devices may correspond to use for different varieties of organic materials respectively, and a heating temperature and a heating time needed by each variety of organic materials are different, so that heating conditions needed by each variety of organic materials may be correspondingly set as different atomization modes and stored in a memory. When the atomization devices provided with different marking members 500 are connected to the vaporizer body, the identification module may identify the atomization device and the corresponding atomization mode needed by the organic materials according to the collected electrical parameters, and the control module controls operation of the heating element 200 to heat the organic materials at a corresponding temperature for a corresponding time, so that the vaporizer may adapt to different atomization devices to heat in different working modes, thus achieving improved atomization for different organic materials.

In some embodiments of the present invention, the marking member 500 is a resistor . Specifically, the marking member 500 may be the resistor, and resistors with different resistance values are mounted on different atomization devices, so that the identification module and the control module may switch different atomization modes for different atomization devices according to resistance value information of the resistors, thus being convenient for a user to atomize and use different varieties of organic materials for exemplary atomization.

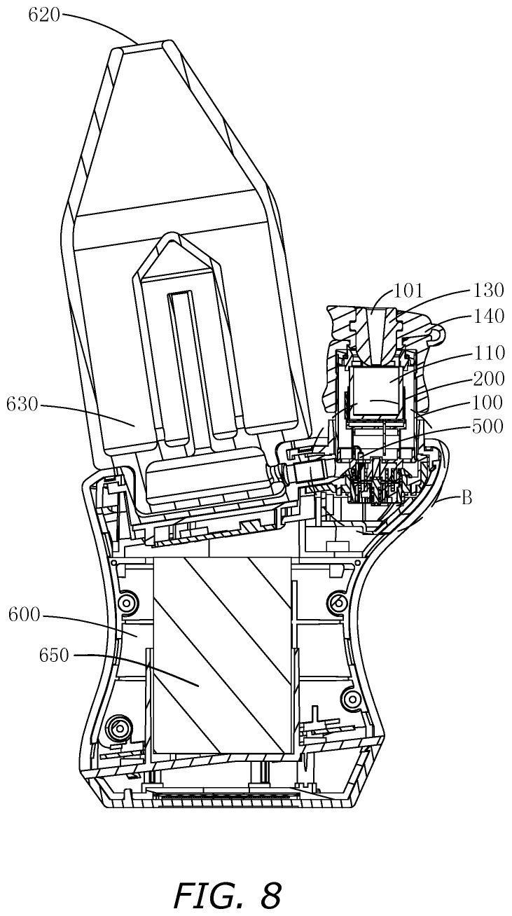

In some embodiments of the present invention, the vaporizer device further comprises a power supply module and a temperature measurement module. The temperature measurement module is incorporated with the motherboard and functions to provide real-time temperature readings of the material chamber 110 as further detailed below. The power supply module refers to a module containing one or more batteries to provide the power supply for the atomization device. As shown in FIG. 8, according to an embodiment of the present disclosure, the one or more batteries 650 of the power supply module may be housed within the base portion 600 of the vaporizer device. The other end of the first thermo-electrode lead 310 is connected with the power supply module and the temperature measurement module respectively, and the other end of the second thermo-electrode lead 320 is connected with the power supply module and the temperature measurement module respectively.

It should be noted that when the first thermo-electrode lead 310 and the second thermo-electrode lead 320 supply electric energy to the heating element 200 for heating, there may be an electric current in the heating element 200, and the electric current will affect a result of converting the thermoelectric electromotive force measured by the thermocouple into the temperature, so that a power supply function and a temperature measurement function of the first thermo-electrode lead 310 and the second thermo-electrode lead 320 may be realized by the power supply module and the temperature measurement module respectively, wherein the power supply module and the temperature measurement module may both be integrated with the main circuit or control module (e.g., motherboard, CPU, MCU, etc.). Specifically, when the temperature is measured by the temperature measurement module, the power supply module stops supplying the electric energy to the heating element 200, so that extra electric current is prevented from affecting the temperature measurement result of the thermocouple, thus being beneficial for improving an accuracy of temperature measurement.

According to some embodiments of the present disclosure, the vaporizer device further comprises a driving module connected with the power supply module and the temperature measurement module respectively, and the driving module is configured for controlling alternating operation of the power supply module and the temperature measurement module. The driving module may be a driving circuit or a driving chip, and operating states of the power supply module and the temperature measurement module may be controlled by the driving module respectively, so that the first thermo-electrode lead 310 and the second thermo-electrode lead 320 may be switched to different working modes, for example, the driving module may control switching on and off of the power supply module and the temperature measurement module according to a high-frequency square wave signal. When the high-frequency square wave signal is at a low level, the driving module makes the power supply module start working and makes the temperature measurement module stop working to switch to a power supply mode. When the high-frequency square wave signal is at a high level, the power supply module stops working and the temperature measurement module starts working to switch to a temperature measurement mode, so that the power supply module and the temperature measurement module may be operated alternately to switch between two functional modes, thus being convenient to dynamically detect a real-time heating temperature by the thermocouple, and being beneficial for realizing accurate temperature control.

In some embodiments of the present invention, as shown in FIG. 2 and FIG. 8, the shell 100 is provided with an accommodating cavity, the material chamber 110 is located in the accommodating cavity, the shell 100 is provided with an air inlet 101 communicated with the accommodating cavity, and an air flow passing through the air inlet 101 is capable of being blown to an inner bottom portion of the material chamber 110.

It should be noted that since the organic materials generally need to be placed at the bottom portion of the material chamber 110 for heating and atomization, atomized gas formed by heating and atomization of the organic materials may also be accumulated at the bottom portion of the material chamber 110, and the atomized gas accumulated at the bottom portion of the material chamber 110 can be disturbed and lifted by an impact of the air flow by blowing the air flow passing through the air inlet 101 to the inner bottom portion of the material chamber 110. The atomized gas lifted in the material chamber 110 passes through an air vent 102 and an air outlet 103 in the shell 100 in sequence and then flows out, thus being convenient for a user to draw the atomized gas for inhalation.

In some embodiments of the present invention, as shown in FIG. 2 and FIG. 8, the shell 100 is also provided with a hollow tubular air inflow guide member 130, the air inflow guide member 130 is provided with a through hole forming the air inlet 101, one end of the air inflow guide member 130 is located in the material chamber 110, and the other end of the air inflow guide member 130 extends out of the accommodating cavity for ambient air intake. The air inflow guide member 130 may be composed of ceramics, glass, titanium, etc.

Specifically, the air inflow guide member 130 may be an air nozzle made of borosilicate glass, and the air nozzle has a hollow interior to form the air inlet 101. Since the borosilicate glass has a high temperature resistance, an air outflow end of the borosilicate glass air nozzle may extend into the material chamber 110. Meanwhile, an air inflow end of the borosilicate glass air nozzle is communicated with the outside for the intake of ambient air, and when the user draws vapor air out of the suction nozzle 620, ambient air flows into the air inflow end of the borosilicate glass air nozzle, and flows through the hollow through hole and the air outflow end of the high borosilicate glass air nozzle to enter the material chamber 110, so that the atomized gas accumulated at the bottom portion of the material chamber 110 may be disturbed and lifted for atomization for the user to draw out through the suction nozzle 620, thus having a simple structure, being easy to implement, and being beneficial for improving a turbulence effect of an air inflow on the atomized gas at the bottom portion of the material chamber 110.

In some embodiments of the present invention, as shown in FIGS. 1-2 and FIG. 8, the shell 100 is also provided with a heat insulation assembly 140. It can be understood that the user may be prevented from being scalded by directly contacting with the shell 100 via providing the heat insulation assembly 140, wherein the heat insulation assembly 140 may be made of silica gel. Specifically, with reference to FIG. 1 to FIG. 2 and FIG. 8, the heat insulation assembly 140 comprises a silica gel sleeve 141 and a silica gel cover 142. The silica gel sleeve 141 is sleeved on an outer peripheral wall of the shell 100 to realize a scalding prevention function, and the silica gel cover 142 is connected with the silica gel sleeve 141 by a buckle to seal the material chamber 110 in the accommodating cavity of the shell 100. It should be noted that the air inflow guide member 130 may also be arranged on or integrated in the silica gel cover 142, so that the air inflow guide member 130 may be connected with the silica gel cover 142, thus avoiding the air inflow guide member 130 from being easily lost when removed to input organic materials into the material chamber 110.

It should be noted that before using the atomization device, the user may first open the silica gel cover 142 to add the organic materials corresponding to the atomization device into the material chamber 110, and then connect the silica gel cover 142 with the silica gel sleeve 141 by the buckle for sealing. At the moment, the air outflow end of the air inflow guide member 130 will extend into the material chamber 110, and after the user assembles the atomization device on a base body 600 of the vaporizer, with reference to FIG. 5 to FIG. 9, an identification portion 610 on the base body 600 is in conductive contact with an electric conduction part 120 on the shell 100 of the atomization device. It can be understood that the identification portion 610 and the electric conduction part 120 may both be a bump or a boss made of a conductive metal material such as copper or aluminum, so that the identification module can be electrically connected with the marking member 500 inside the shell 100. According to electrical parameter information of the marking member 500, the atomization mode needed by the organic materials corresponding to the atomization device may be identified, and the control module controls operation of the heating element 200 to heat the organic materials in the material chamber 110 for atomization so as to form the atomized gas. Since the air inlet 101, the air vent 102 and the air outlet 103 in the shell 100 are communicated with a filter assembly 630 and a suction nozzle 620 on the base body 600 after the atomization device is assembled on the base body 600, the user may check a heating temperature and a heating time of the organic materials in real time through a display screen 640 on the base body 600. When the organic materials are heated and atomized completely, the user sucks the atomized gas at the suction nozzle 620. At the moment, air flows into the material chamber 110 from the air inlet 101 first and disturbs the atomized gas at the bottom portion of the material chamber 110, so that the atomized gas at the bottom portion of the material chamber 110 is lifted and mixed with the air, and then a mixed air flow of the air and the atomized gas flows out of the air vent 102 and the air outlet 103, filtered by the filter assembly 630 and drawn out by the user for inhalation through the suction nozzle 620, so that the atomization device not only may conveniently atomize different varieties of organic materials, but also is beneficial for improving atomization and inhalation of the organic materials.

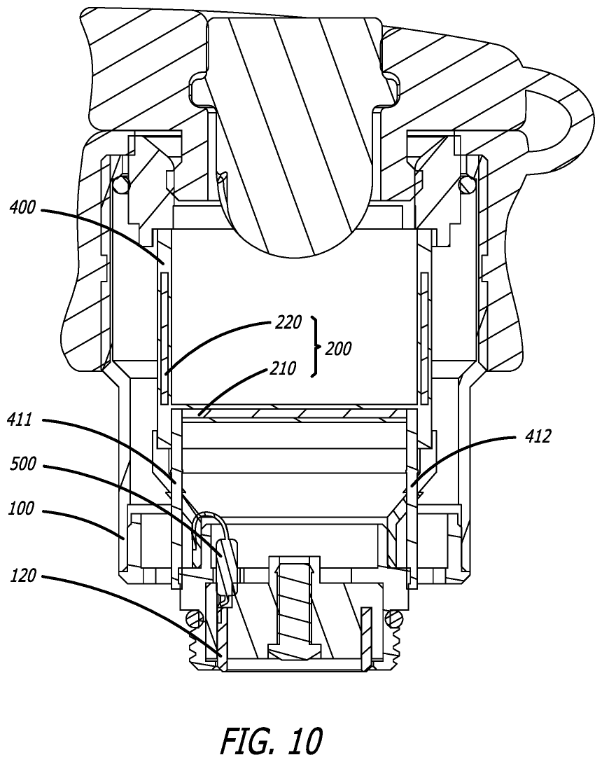

With reference to FIGS. 10-12, an atomization device according to another embodiment is shown. The atomization device includes: a shell 100, a thermosensitive heating assembly 200, a heating bowl or heating container 400, and a temperature measuring structure. The heating container 400 defines an internal cavity or heating chamber for placement of organic materials. The heating container 400 is arranged in the shell 100, the thermosensitive heating assembly 200 is arranged on or within the walls of the heating container 400, and the temperature measuring structure is arranged in the shell 100 for measuring a temperature of the heating container 400.

It should be noted that, after a user puts an organic material in the heating chamber of the heating container 400, the heating container 400 is heated by the thermosensitive heating assembly 200, so that the organic material may be atomized to form vapor for the user to intake. The thermosensitive heating assembly 200 is made of a thermosensitive resistance material, such as a heating wire (having many forms including cylindrical, elongated strip, etc.) made of nickel, titanium or other metal materials, wherein the heating wire is wound around an outer peripheral wall of the heating container 400 to heat the heating container, or a heating circuit made of a tungsten paste or a silver or platinum series resistance paste, wherein the heating circuit is built on or within the walls of the heating container 400 to heat the heating container 400 after being electrified. Since a resistance value of the thermosensitive resistance material has a positive or negative temperature coefficient relationship with a temperature, when the thermosensitive heating assembly 200 is electrified to convert electric energy into heat energy for heating, a current heating temperature of the thermosensitive heating assembly 200 may be judged by a TCR technology according to a resistance value of the thermosensitive heating assembly. It can be understood that, generally, the heating temperature of the thermosensitive heating assembly 200 may be equal to a current heating temperature of the organic material within the heating container 400, and the user may adjust the temperature according to an atomization heating requirement and the measured heating temperature of the thermosensitive heating assembly 200 to realize a temperature control function of the atomizing device.

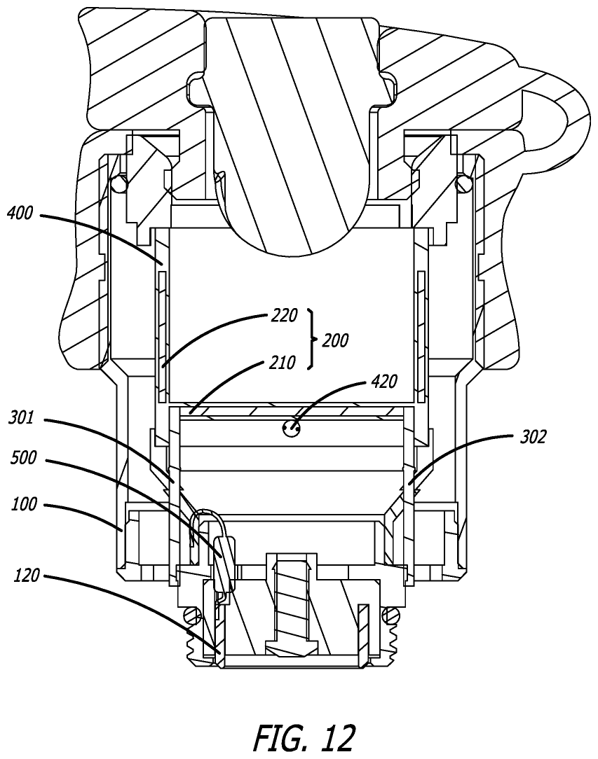

In some embodiments of the present disclosure, the temperature measuring structure may be an infrared temperature measuring probe which is used for non-contact temperature measurement, or a Positive Temperature Coefficient (PTC) temperature sensor or a Negative Temperature Coefficient (NTC) temperature sensor 420 which is common in the market at present and used for detecting the temperature of the heating container 400. Specifically, with reference to FIG. 12, the temperature measuring structure of the NTC temperature sensor 420 is taken as an example for specific description. A first conductive lead wire 301 and a second conductive lead wire 302 are conductively connected with the thermosensitive heating assembly 200 arranged on the heating container 400, wherein the first conductive lead wire 301 and the second conductive lead wire 302 may be nickel wires or copper wires, so that the thermosensitive heating assembly 200 may be electrified to convert electric energy into heat energy for heating. When the first conductive lead wire 301 and the second conductive lead wire 302 stop electrifying the thermosensitive heating assembly 200, a current heating temperature of the heating container 400 may be detected by the NTC temperature sensor 420 arranged on a bottom portion of the heating container 400. In addition, it should be understood that, considering that heat generated by the thermosensitive heating assembly 200 may be consumed during conduction to the heating container 400, when the thermosensitive heating assembly 200 is electrified to be heated, not only the TCR technology may be used to measure the heating temperature of the thermosensitive heating assembly 200, but also the NTC temperature sensor 420 may be used to simultaneously measure an actual heating temperature of the heating container 400, and two temperature values may be simultaneously displayed to a user for viewing and reference, thus being convenient for the user to flexibly control a heating temperature of the atomizing device according to atomization heating requirements of different organic materials. Thus, it can be seen that, a limitation of temperature measurement by the TCR is overcome by adding the temperature measurement structure, and the user can know the current heating temperature of the heating container 400 in real-time whether the thermosensitive heating assembly 200 is electrified to be heated or not, thus realizing more convenient measurement and more flexible control of the heating temperature of the atomizing device.

In some embodiments, as shown in FIG. 10 and FIG. 12, the temperature measuring structure is a contact temperature measuring structure, and the contact temperature measuring structure is connected with the heating container 400.

It should be noted that, compared with non-contact temperature measurement such as infrared temperature detection, temperature measurement of the heating container 400 by using the contact temperature measurement structure connected with the heating container 400 can reduce an influence of a distance on a temperature measurement accuracy, thus being beneficial for improving a measurement accuracy of a current actual heating temperature of the heating container 400.

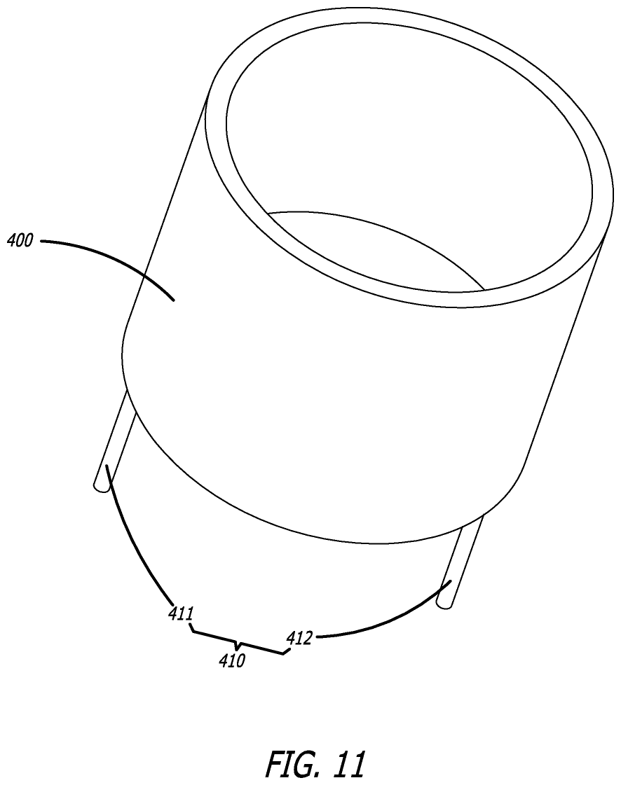

In some embodiments, as shown in FIGS. 10-11, the contact temperature measuring structure comprises a thermocouple assembly 410 arranged on the heating container 400.

Specifically, with reference to FIGS. 10-11, the thermocouple assembly 410 and the heating container 400 may be used to measure the temperature of the heating container 400, and the thermocouple may not have temperature deviation during working at high temperature for a long time, thus having a high temperature measurement accuracy and a good stability.

In some embodiments, as shown in FIGS. 10-11, the thermocouple assembly 410 comprises a first thermo-electrode lead wire 411 and a second thermo-electrode lead wire 412 arranged on the heating container 400, wherein one end of the first thermo-electrode lead wire 411 is connected with one end of the thermosensitive heating assembly 200, and one end of the second thermo-electrode lead wire 412 is connected with the other end of the thermosensitive heating assembly 200.

The first thermo-electrode lead wire 411 and the second thermo-electrode lead wire 412 may be made of a conductor or semiconductor material, wherein the first thermo-electrode lead wire 411 and the second thermo-electrode lead wire 412 are made of dissimilar materials. For example, the first thermo-electrode lead wire 411 and the second thermo-electrode lead wire 412 may be made of nickel chromium and nickel silicon respectively. Since one end of each of the first thermo-electrode lead wire 411 and the second thermo-electrode lead 412 are both connected with one end of the thermosensitive heating assembly 200, with reference to FIGS. 10-11, the first thermo-electrode lead wire 411 and the second thermo-electrode lead wire 412 may be used as conductive wires to conduct electricity to the thermosensitive heating assembly 200 so as to heat the thermosensitive heating assembly. It can be understood that, the other end of each of the first thermo-electrode lead wire 411 and the second thermo-electrode lead wire 412 are connected with a measuring instrument into a closed loop to form the thermocouple. It should be noted that, since the thermosensitive heating assembly 200 is made of a thermosensitive heating resistance material, the thermosensitive heating assembly not only can generate heat, but also has a conductivity so as to be used as a conductor.

According to a thermoelectric effect and a third conductor law of the thermocouple, the thermosensitive heating assembly 200 may generate a thermo-electromotive force in the loop of the thermocouple after being electrified to be heated, and two ends of the thermosensitive heating assembly 200 used as a third conductor have the same temperature. Connection of the thermosensitive heating assembly 200 to the loop of the thermocouple has no influence on a total electromotive force of the loop of the thermocouple, so that the current actual heating temperature of the heating container 400 may be detected by measuring the thermo-electromotive force through the measuring instrument and converting thermo-electromotive force into a temperature value. It should be noted that, the first thermo-electrode lead wire 411 and the second thermo-electrode lead wire 412 are conductively connected with two ends of the thermosensitive heating assembly 200, so that the thermosensitive heating assembly 200 may be electrified to be heated by using the first thermo-electrode lead wire 411 and the second thermo-electrode lead wire 412 as a positive electrode conductive lead wire and a negative electrode conductive lead wire, and the heating temperature of the heating container 400 is measured by the TCR technology according to a resistance value of the thermosensitive heating assembly 300. However, when the thermosensitive heating assembly 200 ceases being electrified, the thermosensitive heating assembly 200 still has a high temperature under an action of residual heat. At such moment, the loop of the thermocouple formed by connecting the first thermo-electrode lead wire 411, the second thermo-electrode lead wire 412 and the thermosensitive heating assembly 200 enables continuous measurement of the actual heating temperature of the heating container 400. The above structure of matching the temperature measurement by the TCR with the temperature measurement by the thermocouple is used, thus being beneficial for reducing use and mounting of accessories such as the conductive lead wires, making an internal structure of the atomizing device simpler and more compact, and achieving convenient and efficient whole assembly.

In some embodiments, as shown in FIGS. 10-12, the thermosensitive heating assembly 200 and the heating container 400 are in an integrated structure. That is, the thermosensitive heating assembly 200 is disposed within the sidewall and bottom wall of the heating container 400.

It should be noted that, the thermosensitive heating assembly 200 and the heating container 400 are in the integrated structure, which can reduce a workload of later assembly, thus being beneficial for improving processing and production efficiencies of the atomizing device. Specifically, for example, the heating container 400 may be made of an aluminum oxide ceramics material with excellent thermal conductivity and insulation, a container body of the heating container 400 may be composed of two substrate layers of the aluminum oxide ceramics material, and a heating circuit made of a thermosensitive heating resistance paste is printed between the two substrate layers as the thermosensitive heating assembly 200. Then, the two substrate layers are connected into a whole by high-temperature sintering, so that the thermosensitive heating assembly 200 and the heating container 400 may be combined into the integrated structure as shown in FIG. 11, thus being convenient for later assembly and use.

In some embodiments, as shown in FIG. 10 and FIG. 12, the heating container 400 is provided with an accommodating cavity with an upper opening, and the thermosensitive heating assembly 200 is arranged on a bottom wall portion and a sidewall portion of the heating container 400.

It should be noted that, with reference to FIG. 10 and FIG. 12, the bottom portion and the side wall portion of the heating container 400 are both heated by the thermosensitive heating assembly 200, thus resulting in heating of the entire heating container 400. Compared with single-sided heating in a traditional atomizing device with a heating structure of only a bottom surface or only a side surface, the whole heating is more uniform and efficient, thus being beneficial for improving an atomizing effect of the heating container 400 on the organic material.

In some embodiments, as shown in FIG. 10 and FIG. 12, the thermosensitive heating assembly 200 comprises a first heating element 210 and a second heating element 220, the first heating element 210 is arranged on the bottom wall portion of the heating container 400, and the second heating element 220 is arranged on the sidewall portion of the heating container 400.

Specifically, the thermosensitive heating assembly 200 may be composed of the first heating element 210 and the second heating element 220, wherein the first heating element 210 is used for heating the bottom wall portion of the heating container 400, and the second heating element 220 is used for heating the sidewall portion of the heating container 400, so that the user may electrify the first heating element 210 and the second heating element 220 at the same time to realize uniform heat distribution within the material chamber 400. Alternatively, the user may initiate a function wherein only the first heating element 210 is electrified to heat the bottom wall surface of the heating container 400, or only the second heating element 220 is electrified to heat the sidewall surface of the heating container 400 only. It can be seen that, the first heating element 210 and the second heating element 220 enrich the heating modes of the heating container 400, thus being beneficial for expanding heating atomization functions of the atomizing device.

In some embodiments of the present disclosure, the heating container 400 is made of a material comprising an inorganic nonmetallic material.

The inorganic nonmetallic material may be quartz, glass or ceramic. Due to better high-temperature resistance, these materials may not generate peculiar smell during high-temperature heating to mix into the vapor formed by atomizing the organic material, so that the vapor has a higher purity and a better taste.

In some embodiments, as shown in FIG. 10 and FIG. 12, the vaporizer device further comprises a marking member 500 (contained on the atomization device), an identification module and a control module. The marking member 500 is arranged in the shell 100, the identification module is connected with the marking member 500 through the electric conductive portion 120 to collect electrical parameters of the marking member 500, and the control module is connected with the identification module to control operation of the thermosensitive heating assembly 200 according to the electrical parameters.

The marking member 500 may be an electronic component such as a resistor or a potentiometer with different electrical parameters, the identification module may be a circuit module or a chip for collecting the electrical parameters of the marking member 500, and the control module may be a central processing unit (CPU) or may be composed of a microcontroller unit (MCU) and a peripheral circuit thereof. It can be understood that, the identification module and the control module are generally arranged on a base body 600 of a vaporizer device. The atomizing device as shown in FIG. 10 and FIG. 12 has different temperature measurement structures respectively to realize the temperature control function, so that the electrical parameters of the marking member 500 in FIG. 10 and FIG. 12 may be set to be different. Specifically, taking the marking member 500 used as the resistor as an example, resistance values of the resistor may be set to correspond to different modes of the control module. Further, with reference to FIG. 10 and FIG. 12, the shell 100 of the atomizing device is provided with an electric conductive portion 120, and the electric conductive portion 120 is electrically connected with the marking member 500. With reference to FIGS. 5-6, the identification module is provided with an identification portion 610, the identification portion 610 is arranged on the base body 600 of the vaporizer device, and the atomizing device is detachably connected with the base body 600 of the vaporizer device, so that the user may assemble different atomizing devices on the base body 600 of the vaporizer device for use. When the user assembles the atomizing device on the base body 600 of the vaporizer device, the identification portion 610 of the identification module will be conductively contacted with the electric conductive portion 120 of the shell 100, so that the identification module is electrically connected with the marking member 500 to collect a specific resistance value of the marking member 500. It can be understood that, since different atomizing devices may have different temperature measurement and temperature control modes, if multiple atomizing devices respectively correspond to different organic materials, heating conditions such as heating temperature and time required during atomization of each organic material are different, so that different atomization heating modes may be set correspondingly by using different resistance values of the marking member 500 and stored in a memory. The control module reads the set corresponding atomization heating modes according to the specific resistance values of the marking member 500 collected by the identification module to control operation of the thermosensitive heating assembly 200, so that different atomization heating modes may be switched according to different organic materials and different atomizing devices to achieve a good heating atomization effect.

As shown in FIGS. 5-7, an electric vaporizer device according to an embodiment of the present invention comprises the atomization device according to any one of the embodiments above.

Specifically, with reference to FIGS. 5-7, the electric vaporizer device may comprise the atomization device disclosed in any of the embodiments above and a base body 600, wherein the atomization device is assembled on or electrically coupled to the base body 600. The base body 600 is provided with a display screen 601 and a button 602. The atomization device may measure an actual heating temperature of the heating container 400 when the thermosensitive heating assembly 200 is electrified to be heated as well as when the thermosensitive heating assembly 200 is stopped being electrified to be heated respectively by using the temperature measuring structure according to a resistance value of the thermosensitive heating assembly 200 by the TCR technology. The measured temperature values may be displayed on the display screen 640 to the user for viewing, so that the user may know the current heating temperature of the atomization device in real time, and the user may further adjust the temperature by operating the button 602 on the base body 600 according to different heating conditions required by different organic materials, thus being convenient for the user to realize flexible temperature control of heating atomization.

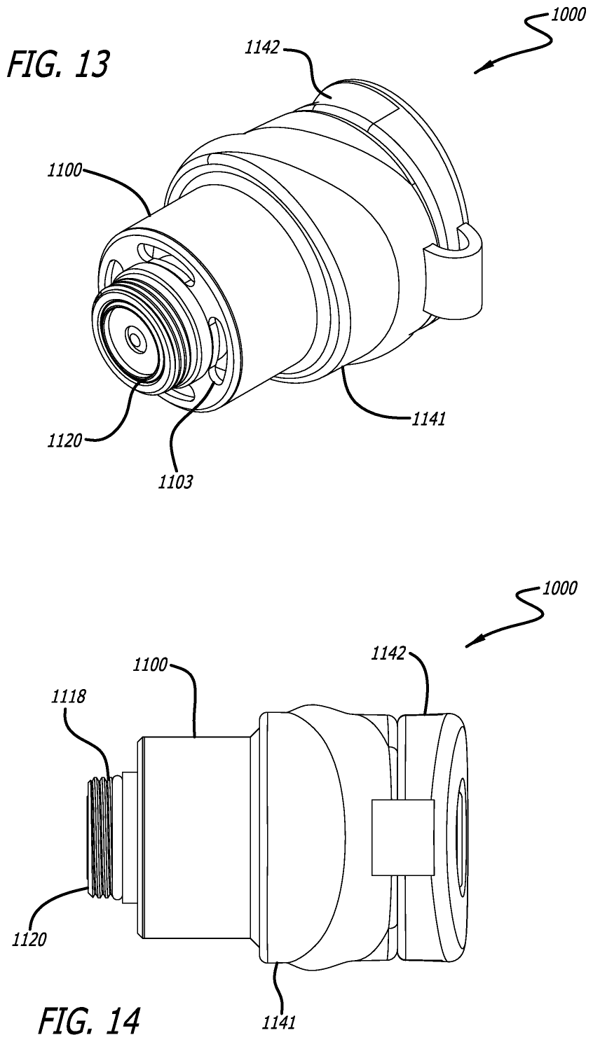

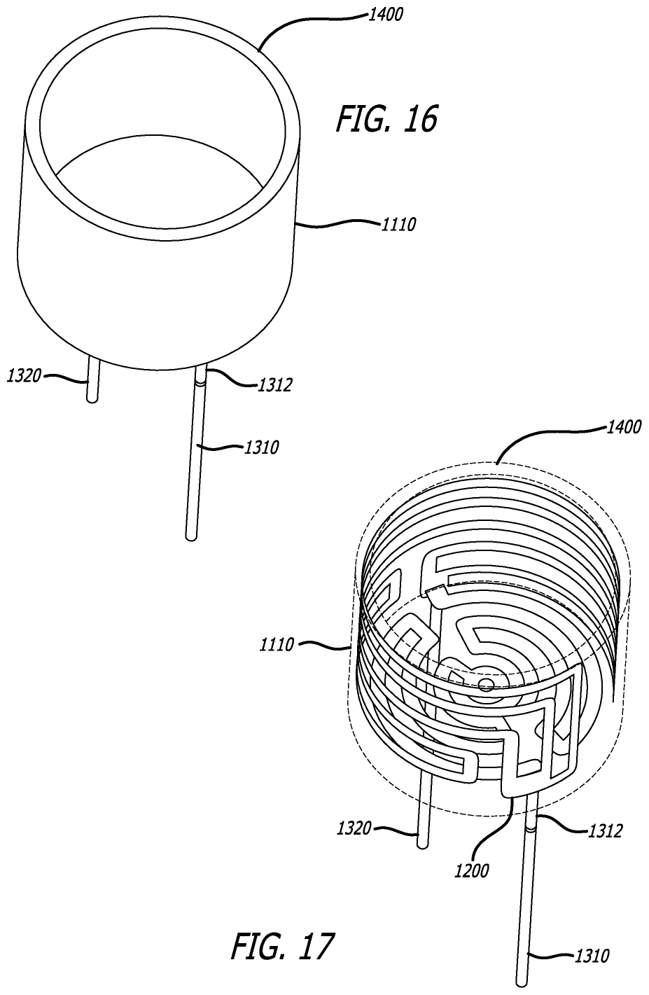

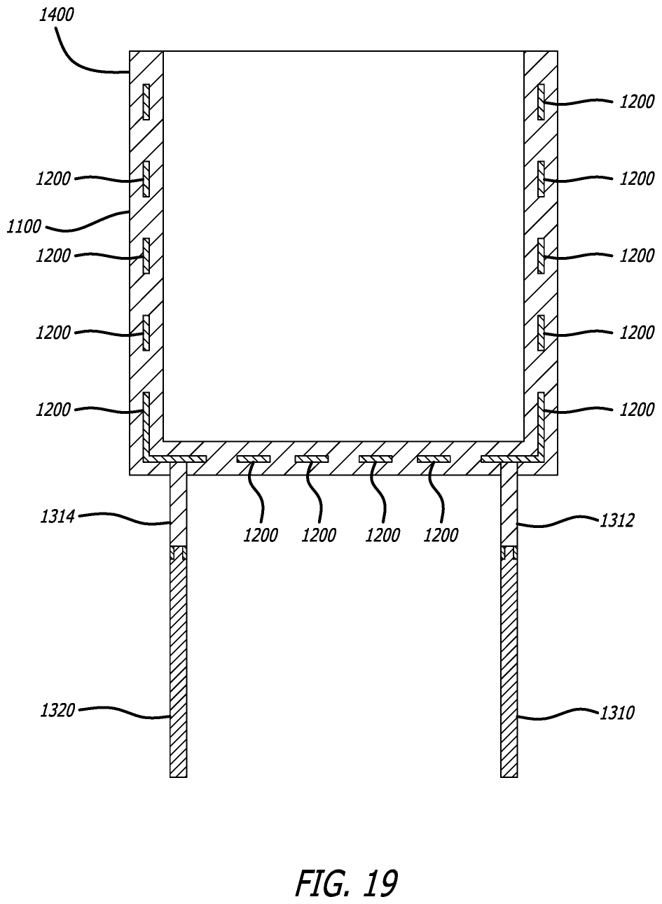

As shown in FIGS. 13-20 for purposes of illustration, a second embodiment of the present invention provides an improved atomization device or atomizer 1000. The atomizer device 1000 is similar to the devices illustrated in FIGS. 1-12, and operates in a similar manner. The atomizer 1000 includes an outer shell 1100 (made from various materials including, without limitation, metal (e.g., steel (e.g., SUS303)), a heat insulation sleeve assembly 1140, a heating container 1400, a bowl connector 1112 (made from various materials including, without limitation, metal (e.g., steel (e.g., SUS303)) or ceramic, a base portion 1118 (made from various materials including, without limitation, metal (e.g., steel (e.g., SUS303)), and a carb cap 1142 (which includes air inflow guide member 1130). The air inflow guide member 1130 has an irregular shape in that the air inlet 1101 seen in FIGS. 12 and 17 is on an exterior diagonal in order to improve air flow by creating a vortex and moving the material (e.g., oil) around the inner cavity of the material chamber or heating chamber 1110 of the heating container 1400.

The heating container 1400 includes a heating chamber 1110 (made from various materials including, without limitation, metal, ceramic (e.g., 95-Alumina ceramic), quartz, borosilicate, stainless steel, silicon carbide, aluminum nitride, sapphire, titanium, zirconia, etc.), a heating element 1200 (e.g., made from various materials including Tungsten or a tungsten powder/tungsten paste printed circuit, silver or platinum paste, etc.) disposed within the walls of the heating chamber 1110, a first thermo-electrode lead 1310 (made from various materials including, without limitation, nickel chromium, nickel aluminum, or the like), and a second thermo-electrode lead 1320 (made from various materials including, without limitation, nickel chromium, nickel aluminum, or the like). The heating chamber 1110 forms an internal cavity for holding material to be atomized, the heating element 1200 forms a heating source to heat up the heating chamber 1110, and the thermo-electrode lead 1310, 1320 are used to measure the temperature of the heating chamber 1110. Wires 1312, 1314 electro-mechanically connect the thermo-electrode leads 1310, 1320 to the heating element 1200. Soldering the thermo-electrode leads 1310, 1320 to the wires 1312, 1314 simplifies the assembly of the heating container 1400. The heating element 1200 includes a sidewall portion, and a bottom wall portion. The sidewall and bottom wall portions of the heating element 1200 are connected by the wires 1312, 1314. The wires 1312, 1314 may be made from various materials including, without limitation, metal (e.g., nickel, silver, gold, etc.).

According to some embodiments of the present invention, the resistance of the sidewall portion of the heating element 1200 (disposed on the sidewall of the heating container assembly 1400) may be lower than the resistance of the bottom wall portion of the heating element 1200 (disposed on the bottom wall of the heating container assembly 1400), with heating speed getting faster after power-on, which can preheat the heating chamber 1110. In such an aspect, for example, the heat distribution rate of the sidewall portion may be modulated to a lower percentage of the total heat distribution of the cumulative heat distribution of the sidewall and bottom wall portions of the heating container assembly 1400. If, for example, the heating chamber 1110 is made from ceramic, the pre-heating can help prevent or reduce cracking in the heating chamber 1110 because of thermal expansion and cold contraction. Similarly, in accordance with the present embodiment, the resistance of the bottom wall portion of the heating element 1200 (disposed within the bottom wall portion of the heating container assembly 1400) may be higher than the resistance of the sidewall portion of the heating element 1200, with heating speed slower than on the sidewall after power-on, which can also can help prevent or reduce cracking of the heating chamber 1110. In such an aspect, for example, the heat distribution rate in the bottom wall may be modulated to a higher percentage of the total heat distribution. The sidewall portion of the heating chamber 1110 and the bottom wall portion of the heating chamber 1110 are connected in parallel. When the device 1000 is powered-up and the heating element 1200 starts to heat up, the heat will be quickly transmitted to the whole heating chamber 1110 to make the temperature uniform and even. It should be understood that the preceding embodiment is an example of an aspect of the heating container assembly 1400 and not intended to limit other embodiments of the heating container assembly 1400.

The heat insulation sleeve assembly 1140 prevents the user from being scalded by preventing the user from direct contact with the shell 1100, The heat insulation sleeve assembly 1140 may be made of various materials including, but not limited to, silica gel, silicone, or other similar heat-insulating material. The heat insulation sleeve assembly 1140 includes a sleeve 1141, and a cover 1142. The sleeve 1141 and the cover 1142 may be made from various materials including, but not limited to, silica gel, silicone, or other similar heat-insulating material. The sleeve 1141 is sleeved on an outer peripheral wall of the shell 1100 to realize a scalding prevention function, and the cover 1142 is connected with the sleeve 1141 by a buckle to seal the heating chamber 1110 in the accommodating cavity of the shell 1100. It should be noted that the air inflow guide member 1130 may also be arranged on the cover 1142, so that the air inflow guide member 1130 may be connected with the cover 1142, thus avoiding the air inflow guide member 1130 from being easily lost after being separated. According to an embodiment of the present disclosure, a ceramic lid 1144 is engaged to an end of the outer shell 1100 with an upper O-ring 1143 disposed around the ceramic lid 1144 to provide a seal between the ceramic lid 1144 and the heat insulation sleeve assembly 1140 when the sleeve 1141 is disposed around the ceramic lid 1144. According to other embodiments, the lid 1144 may be made of a material (e.g. stainless steel) other than ceramic having similar high heat resistance that offer stability at the intended upper temperature limits of a specific atomization device. The upper O-ring 1143 may be made of silicone, rubber, or other flexible, high temperature resistant materials so as to form a seal while maintaining stability of structure at high temperatures (e.g. 400-500 degrees Fahrenheit or above).

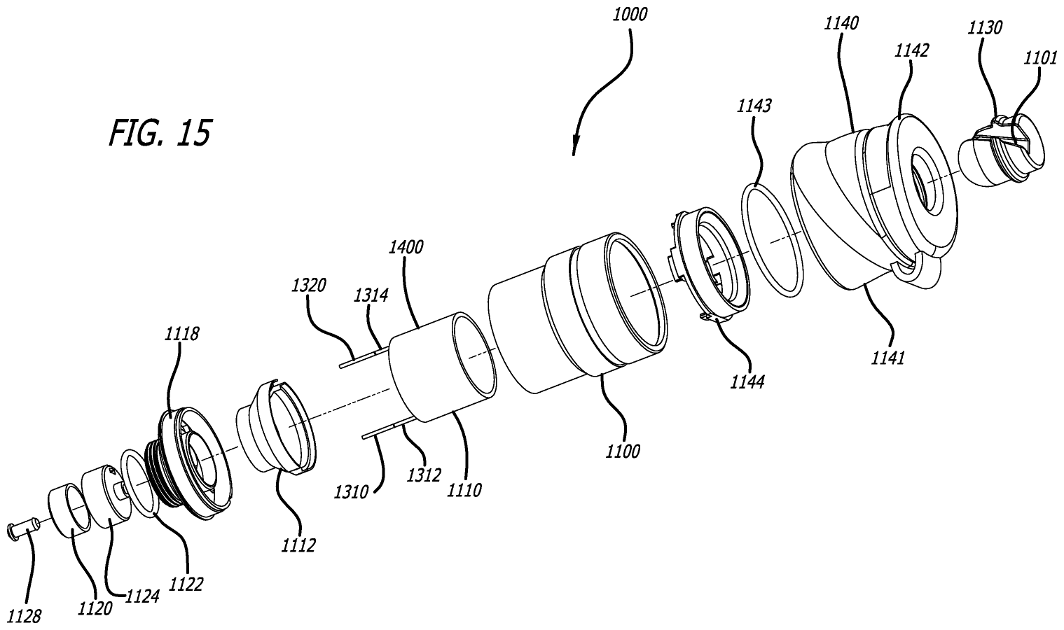

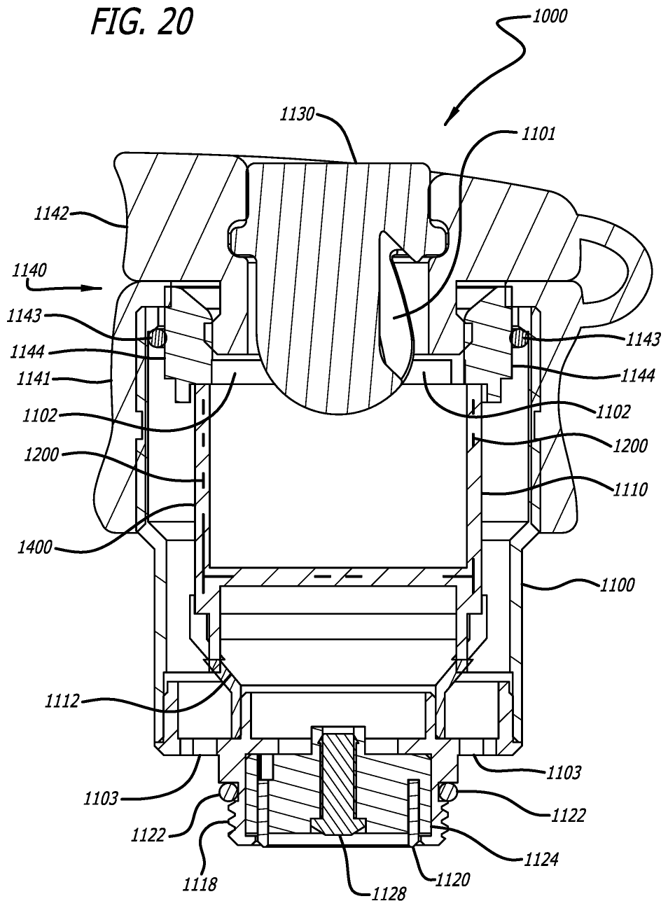

According to some embodiments of the present disclosure, as shown in FIG. 15 and FIG. 20, the shell 1000 and heat insulation assembly 1140 of the atomization device further includes an air inlet 1101, an air vent 1102 (shown in FIG. 20), an air outlet 1103, and an electric conduction part or signal connection ring 1120 (which may be comprised of metal including stainless steel, brass, etc., a lower or base O-ring 1122 (which may have similar properties as the upper O-ring discussed above, e.g. made from silicone, rubber, etc.), an insulator 1124 (which may be made from silicone or other heat-insulating materials discussed above), a signal connection ring 1120 (made from metal including stainless steel, brass, etc.), and an electrode 1128 (which may be made from metal including stainless steel, brass, etc.). The lower or base O-ring 1122 is disposed around the base portion 1118, with the insulator 1124 disposed within the base portion 1118.

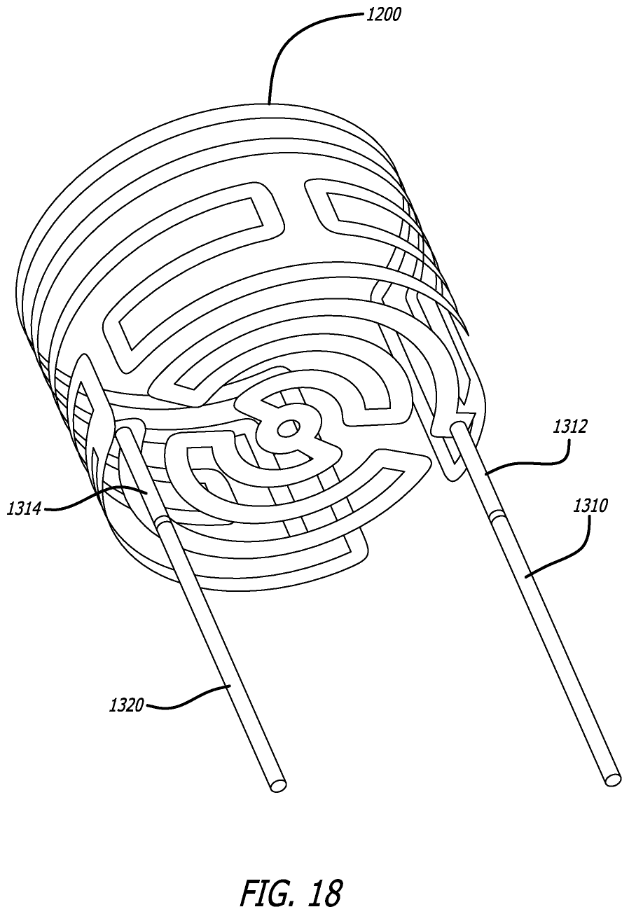

The heating element 1200 is disposed within the walls of the heating chamber 1110 of the heating container 1400 (i.e., inside the sidewalls and bottom wall of the heating chamber 1110), and no separate insert (e.g., material chamber 110) is disposed within the interior cavity of the heating chamber 1110. The heating element 1200 is used for heating the bottom surface and side surfaces of the heating chamber 1110. According to one aspect, the heating element may include first and second segments or portions, wherein the first and second segments are thermally and/or electrically coupled or joined to form the heating element 1200. According to another aspect, the heating element may be a single heating element that extends along the bottom wall and sidewall portion of the heating container assembly 1400. The first thermo-electrode lead 1310 and the second thermo-electrode lead 1320 are arranged in the shell 1100, one end of the first thermo-electrode lead 310 is connected with one end of the heating element 1200, and one end of the second thermo-electrode lead 1320 is connected with the other end of the heating element 1200. As shown in FIGS. 17-18, the heating element 1200 can be in the form of an elongated strip having a generally serpentine shape that winds along the inside of the sidewalls and bottom wall of the heating chamber 1110. According to other embodiments of the present disclosure, the heating element may have a variety of other forms or patterns including said serpentine or a striped, heating sheet, cylindrical, semi-cylindrical, sinusoidal, cross-hatch, herringbone, mesh, or waffle-like pattern. Furthermore, any one of these patterns may vary in dimension with regard to pattern between the bottom wall and sidewall portions of the heating element 1200 or said dimensions may gradually widen or narrow in ascent up or descent down the heating chamber 1110. According to additional embodiments, wherein the heating element portion of the bottom wall or sidewall portion may be a sheet or sheet-like form with cutouts of various patterns and degree. With respect to the above mentioned embodiments of the heating element, including shape patterns or sheet-like portions, the pattern and pattern change may depend upon the shape of the heating chamber 1110 and the intended use of the atomizer. For example, organic materials such as oils or other liquid or quasi-liquid forms may concentrate on the bottom of the material chamber and require tighter patterns on the bottom portion and/or lower portions of the sidewalls of the material chamber, alternatively, flower or other dry or solid materials may require localized heating throughout the sidewall portions of the heating chamber and thus tighter patterns thereon or within said sidewall portions.

Designing a heating element 1200 of the atomizer 1000 that is integrated into the structure of the heating container 1400 provides the benefit of improving efficiency in the assembly of the atomizer 1000. Moreover, the integrated heating structure may also be tested separately in advance before assembly of the entire atomizer 1000, thus avoiding problems with the heating element 1200 that can only be found during detection of finished products after assembly, and is beneficial for improving a yield and a quality control effect.

The shell 1100 may have different shapes, and the heating chamber 1110 is arranged inside the shell 1110. The heating element 1200 may be any one of the embodiments detailed above including a serpentine heating strip as illustrated in FIG. 18 or, according to other embodiments, a resistance wire and a heating sheet, or comprised of a heating circuit made from a tungsten paste or a platinum series resistance paste as detailed above. Through the highly efficient layout of the heating element 1200 within the heating chamber 1110, the whole heating chamber 1110 has a very even and uniform temperature. Generally, material(s) can be atomized directly in the heating chamber 1110. A user may add material(s) into the heating chamber 1110 for heating and atomization, wherein the user may draw air through a suction nozzle of a mouthpiece or filter assembly aligned with an air passage within the base body and/or an air outlet passage of the atomization device so as to create suction, and the bottom surface and the side surface of the heating chamber 1110 may be heated by only one heating element 1200, so that the heating chamber 1110 may be subjected to three-dimension heating.

Various material(s) may be placed within the heating chamber 1110 including, but not limited to, the organic materials enumerated above with respect to the material chamber 110.

Compared with single-side heating, the three-dimensional heating is more uniform and efficient, thus being beneficial for improving an atomization effect of the materials being heated. Moreover, the first thermo-electrode lead 1310 and the second thermo-electrode lead 1320 may both be made of conductor or semiconductor materials, and the materials used for making the first thermo-electrode lead 1310 and the second thermo-electrode lead 1320 are different. For example, the first thermo-electrode lead 1310 and the second thermo-electrode lead 1320 may be made of nickel chromium and nickel silicon respectively. Since one end of the first thermo-electrode lead 1310 and one end of the second thermo-electrode lead 1320 are both connected with the heating element 1200, electric energy (i.e., electrical current) may be supplied to the heating element 1200 for heating up the heating element 1200 by electrical conduction through the heating element 1200 between the first thermo-electrode lead 1310 and the second thermo-electrode lead 1320. The other ends of the first thermo-electrode lead 1310 and the second thermo-electrode lead 1320 are connected with a detection instrument (not shown for clarity), and the two ends of the first thermo-electrode lead 1310 and the second thermo-electrode lead 1320 are combined into a loop to form a thermocouple. It should be noted that since a temperature of the heating element 1200 after heating is high, an electromotive force may be generated in the loop according to a thermoelectric effect, the purpose of temperature measurement may be achieved by measuring a thermo-electromotive force and converting the same, and according to a third conductor law of the thermocouple, a third conductor is connected into the loop of the thermocouple. Introduction of the third conductor has no influence on a total electromotive force of the loop of the thermocouple as long as temperatures at two ends of the third conductor are the same. That is, the “third conductor law” refers to the connection of the intermediate conductor in the thermocouple circuit, also known as the “third conductor” (for example, as set forth below and seen in FIGS. 2-5 and 10-12, the thermosensitive heating assembly 200 is the “third conductor”). Specifically, the heating element 1200 is equivalent to the third conductor, so that temperature detection of the heating element 1200 may be realized by using one ends of the first thermo-electrode lead 1310 and the second thermo-electrode lead 1320 connected with the heating element 1200 as thermal ends, thus realizing a temperature control function on the heating element 1200. Meanwhile, use of a temperature measurement accessory such as a temperature sensor is avoided, so that an internal structure of the atomizer 1000 is simplified, and accessories needed by the atomizer 1000 are reduced, thus allowing assembly and use of the atomizer 1000 to be more convenient and efficient.

In some embodiments of the present invention, as shown in FIGS. 12-17, the three-dimensional heating atomization device 1000 further comprises a heating container 1400 arranged in the shell 1100. The heating chamber 1110 includes a sidewall and bottom wall portion that defines an interior portion having an upper opening. The interior portion of the heating chamber 1110 acts as a heating cavity. As set forth above, the heating element 1200 is arranged inside the bottom wall portion and sidewall of the heating chamber 1110. While the heating chamber 1110 may be made of various materials (including, without limitation, metal, ceramic, and quartz), whichever material is used to form the heating chamber 1110, that material must be able to conduct heat quickly. The heating element 1200 is arranged within the bottom wall portion and sidewall portion of the heating chamber 1110, forming a three-dimensional heating cavity within the body of the heating chamber 1110. The materials to be heated, and thus atomized, are placed in the heating cavity of the heating chamber 1110 to realize the three-dimensional heating atomization of the materials, and result in a higher quality of atomized materials. As discussed in detail above, this improved atomization benefits vapor quantity and volume yield, as well as the taste or flavor of the inhaled substance.

In some embodiments of the present disclosure, the layout of the heating element 1200 within the sidewall and bottom wall portions of the heating chamber 1110 provides varying resistance on the sidewall portion and the bottom wall portion. The heating chamber of the atomization device may be programmed to reach desired temperatures of 500 degrees Fahrenheit or higher in some instances. In order to prevent the heating chamber 1110 from cracking due to thermal expansion and cold contraction from the fluctuation between said high temperatures (e.g. 400-500 degrees Fahrenheit) and then low temperatures (e.g. 380-400 degrees Fahrenheit when the device is in use, as well as room temperature when the device is not in use), the heating element 1200 was designed to provide varying resistance on the sidewall and bottom wall portions of the heating chamber 1110. Varying resistance is provided by materials having different resistance within the sidewall portion and the bottom wall portion. The material used in the sidewall portion and the bottom wall portion may be the same but varying resistance may be achieved through the dimensions of each portion. Integration of the heating element 1200 inside the bottom wall portion and sidewall of the heating chamber 1110 provides the added benefit of speeding up the time it takes to heat the heating chamber 1110 to a desired temperature for vaporizing the material within the heating chamber 1110. An additional benefit of the heating element 1200 being integrated within the heating chamber 1110 is that it provides uniform temperature distribution or heating within the heating cavity, prevents spill over (which reduces cleaning), provides purer vapor (as discussed in detail above), etc. As discussed above, hot spots, cold spots, and temperature gradients within the material chamber and along the surface are of the heating cavity cause inefficient heating of organic materials which may cause said organic materials to gunk up within the heating cavity, as well as spill over into the air vents and further airflow members connecting the heating cavity to the mouthpiece of the device. Varying resistance in the side and bottom walls of the heating chamber 1110 helps reduce cracking between the sidewall of the heating chamber's body and the bottom wall portion of the heating chamber's body. This provides a heat distribution rate where about 20% heat is distributed on the bottom of the heating chamber 1110, and about 80% heat is distributed on the sidewall of the heating chamber 1110. In other words, the resistance of the heating element within or thermally connected to the sidewall portion of the heating chamber 1110 is low, and the heating speed is 80%, while the resistance of the heating element within or thermally connected to the bottom wall portion of the heating chamber 1110 is high, and the heating speed is 20%. Due to different resistance, a low resistance wall has a fast heating speed, the bottom wall of the heating chamber 1110 can be effectively prevented from cracking due to thermal expansion and cold contraction. When the temperature of the whole heating chamber 1110 rises, the temperature of the whole heating chamber 1110 will be quickly balanced due to heat conduction.

The need for the heating chamber 1110 to have crack-resistance is required by, for example, the high temperature generated in the sidewall and bottom wall portion of the heating chamber 1110 during heating causing expansion in the sidewall and bottom wall portion of the heating chamber 1110. The heated sidewall and bottom wall portion of the heating chamber 1110 when then meeting a (relatively) cold material (e.g., oil, wax, or rosin, which may be stored in a refrigerator or in some cases a freezer), and then subsequent contraction of the sidewall and bottom wall portion of the heating chamber 1110 caused by the temperature drop after use. Also, concentrates or other materials can be stored frozen, and then heated within the heating chamber 1110 so it can be important for the heating chamber 1110 to handle varying temperatures. As a supplement to reducing/preventing cracking of the heating chamber 1110, the heating chamber 1110 can also be made from a crack-resistant material to help prevent cracking between the sidewall of the heating chamber's body and the bottom wall portion of the heating chamber's body.

Alternatively, instead of vaporizing the material directly from the heating chamber 1110, an insert (e.g., material chamber 110) may be disposed within the interior cavity of the heating chamber 1110 so that material (e.g., oil) can be convection vapored within the insert (in a manner similar to that described above with regard to the material chamber 110). The insert may also be removable from the heating cavity of the heating container 1400, thus being convenient for cleaning and replacement.

The heating element 1200 provides smooth and uniform heating, which can generate smoother vapor. The full heating element 1200 provides different resistance values on the side wall and bottom wall portion of the heating chamber 1110. In this way, it is convenient to adjust the heating temperature of the heating element 1200 to make the overall heating of the heating chamber 1110 be more uniform.

In some embodiments of the present invention, as shown in FIGS. 14-17, one end of the first thermo-electrode lead 1310 connected with the heating member 1200 and one end of the second thermo-electrode lead 1320 connected with the heating member 1200 are both arranged on the heating container 1400. For example, one end of the first thermo-electrode lead 1310 connected with the heating member 1200 is arranged within the bottom portion of the heating chamber 1110 of the heating container 1400, and one end of the second thermo-electrode lead 1320 connected with the heating element 1200 is arranged within the sidewall of the bowel 1110 of the heating container 400.

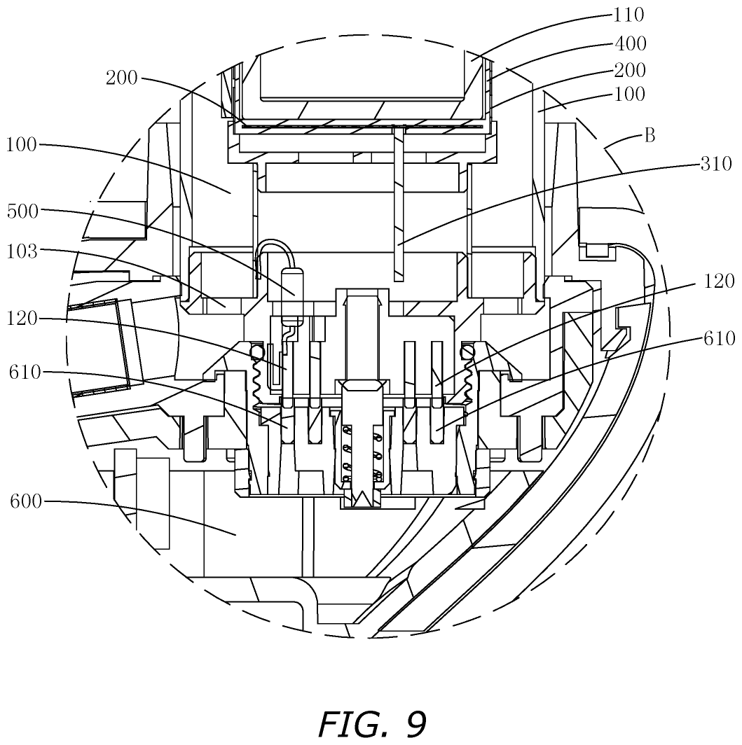

In some embodiments of the present invention, the three-dimensional heating atomization device 1000 may be used in conjunction with a base device (e.g., base body 600 of the vaporizer device, as seen in FIGS. 6-9), and further comprises a marking member 500 (contained in the atomization device), and an identification module and a control module in the base body 600, such as is seen in FIGS. 8-9. The marking member 500 is arranged in the shell 1100. The identification module is connected with the marking member 500 to collect electrical parameters of the marking member 500, and the control module is connected with the identification module to control operation of the heating element 1200 according to the electrical parameters. The marking member 500 functions as described above in connection with the embodiment of the atomization device having shell 100. According to an aspect of the present embodiment, a signal connection ring 1120 may function as an integrated electric conduction portion and marking member as described above, such that the signal connection ring 1120 can let the base device identify the type of the atomization device 1000 when connected. Alternatively, the signal connection ring 1120 interfaces with the identification portion of the base body and is electrically connected with a marking member within the shell 1100.

The marking member 500 may be an electronic component such as a resistor or a potentiometer, with different electrical parameters. The identification module may be a circuit module or a chip, and configured for collecting the specific electrical parameters of the marking member 500. The control module may be a central processing unit (CPU), a microcontroller unit (MCU) and a peripheral circuit thereof, or the like. Specifically, the identification module and the control module may both be arranged on the base body 600 of a vaporizer device, and the marking member 500 arranged in each atomization device is different, for example, a plurality of different atomization devices may correspond to different varieties of materials (e.g., dried botanical material, oil, etc.) respectively, and a heating temperature and a heating time needed by each variety of material are different, so that heating conditions needed by each variety of material may be correspondingly set as different atomization modes and stored in a memory. When the atomization devices provided with different marking members 500 are assembled, the identification module may identify the material loaded in the heating chamber 1110 of the atomization device 1000 and the corresponding atomization mode needed by that material according to the collected electrical parameters, and the control module controls operation of the heating element 1200 to heat the material in the heating chamber 1110 at a corresponding temperature for a corresponding time, so that there is adaptation to different atomization devices to heat in different working modes, thus achieving a good atomization effect for different materials.

In some embodiments of the present invention, the marking member 500 is a resistor.

Specifically, the marking member 500 may be the resistor, and resistors with different resistance values are mounted on different atomization devices, so that the identification module and the control module may switch different atomization modes for different atomization devices according to resistance value information of the resistors, thus being convenient for a user to atomize and use a variety of different materials and obtaining a good atomization taste.

In some embodiments of the present invention, the three-dimensional heating atomization device further comprises a power supply module (not shown for clarity) and a temperature measurement module (not shown for clarity). The other end of the first thermo-electrode lead 1310 is connected with the power supply module and the temperature measurement module respectively, and the other end of the second thermo-electrode lead 1320 is connected with the power supply module and the temperature measurement module respectively.

It should be noted that when the first thermo-electrode lead 1310 and the second thermo-electrode lead 1320 supply electric energy to the heating element 1200 for heating, there may be an electric current in the heating element 1200, and the electric current will affect a result of converting the thermoelectric electromotive force measured by the thermocouple into the temperature, so that a power supply function and a temperature measurement function of the first thermo-electrode lead 1310 and the second thermo-electrode lead 1320 may be realized by the power supply module and the temperature measurement module respectively, wherein the power supply module and the temperature measurement module may both be the circuit module or the chip. Specifically, when the temperature is measured by the temperature measurement module, the power supply module stops supplying the electric energy to the heating element 1200, so that extra electric current is prevented from affecting the temperature measurement result of the thermocouple, thus being beneficial for improving an accuracy of temperature measurement.

In some embodiments of the present invention, the vaporizer device further comprises a driving module connected with the power supply module and the temperature measurement module respectively, and the driving module is configured for controlling alternating operation of the power supply module and the temperature measurement module. The driving module may be a driving circuit or a driving chip, and operating states of the power supply module and the temperature measurement module may be controlled by the driving module respectively, so that the first thermo-electrode lead 1310 and the second thermo-electrode lead 1320 may be switched to different working modes, for example, the driving module may control switching on and off of the power supply module and the temperature measurement module according to a high-frequency square wave signal. When the high-frequency square wave signal is at a low level, the driving module makes the power supply module start working and makes the temperature measurement module stop working to switch to a power supply mode. When the high-frequency square wave signal is at a high level, the power supply module stops working and the temperature measurement module starts working to switch to a temperature measurement mode, so that the power supply module and the temperature measurement module may be operated alternately to switch between two functional modes, thus being convenient to dynamically detect a real-time heating temperature by the thermocouple, and being beneficial for realizing accurate temperature control.

When heating of the heating chamber 1110 starts, programming within the base body 600 of the vaporizer device will start control of the whole heating chamber's temperature with TCR (Temperature Coefficient of Resistance); measuring the real-time temperature, and making efficient compensation to the real-time temperature during operation if the unit identifies that the real temperature of the material or heating chamber differs from the desired or selected temperature. For example, when a user selects a specific temperature for the material chamber or heating chamber of the atomization device (e.g. 300 or 500 degrees Fahrenheit, but not limited thereto), the rate at which the material or heating chamber reaches the selected temperature may depend upon a variety of factors including but not limited to the temperature of ambient air, the type of organic material inserted within the chamber, as well as whether the atomization device is in a first or concurrent use.

It should be understood that the heat or power required to bring the material or heating chamber to a specific temperature will vary depending upon the temperature of said heating or material chamber upon initiating heating of the same. For example, when a user prompts the atomization device to heat the chamber a first time or when the chamber is at room temperature will require higher or longer heat from the heating element in comparison to when a user prompts the atomization device to heat (or reheat) the chamber prior to the chamber cooling to the room temperature or similar. Furthermore, environments including hot or cold (depending on geographic location and indoor/outdoor use) as well as elevation may affect the rate at which the atomization device reaches a pre-selected temperature. As detailed further herein, the first and second thermo-electrode leads or thermocouple enable the real-time measurement of the atomization device, and specifically the real-time measurement of the temperature of the material or heating chamber of the atomization device so as to provide feedback to the control module which efficiently compensates with respect to the same. Specifically, according to embodiments of the present disclosure, an atomization device is enabled to provide real-time temperatures of the material or heating chamber when the chamber is or is not concurrently being heated.

When the heating chamber 1000 is not being heated, programming within the base unit will immediately switch to using thermocouples to measure the heating chamber's real-time temperature. Once not in heating, the thermo-electrode leads 1310, 1320 performs the function to measure the real-time temperature within the heating chamber 1110. The purpose is to simplify the device 1000 by eliminating the need for other components to measure temperature, and provide accurate temperature control. During the heating process, the TCR of the thermocouple works to measure the real-time temperature. It should be noted that since one end of the first thermo-electrode lead 1310 connected with the heating element 1200 and one end of the second thermo-electrode lead 1320 connected with the heating element 1200, both are used as the thermal ends of the thermocouple for temperature measurement, with the thermal ends of the thermocouple arranged on the heating container 1400 so that a temperature detected by the thermocouple is a temperature at the heating chamber 1110 of the heating container 1400, which means that the temperature detected by the thermocouple is an actual heating temperature of the materials within the heating cavity of the bowel 1110, and is not just a heating temperature of the heating element 1200, thus realizing more accurate temperature control heating of the materials within the heating chamber 1110, and being beneficial for improving the atomization effect of the materials within the heating chamber 1110.

In some embodiments of the present invention, as shown in FIGS. 10-17, the shell 1100 is provided with an air inlet 1101 communicating with the heating cavity of the heating chamber 1110, and an air flow passing through the air inlet 1101 is capable of being blown to an inner bottom portion of the heating chamber 1110.

In general, for some organic materials (e.g., oil) put in the heating or material chamber, gravity will bring those materials to the bottom of the heating chamber 1110, but air flow will pull that material (e.g., oil) up onto the sidewall of the heating chamber 1110. As both the sidewall and bottom wall of the heating chamber 1110 have integrated heating, the material (e.g., oil) will still be heated. It should be noted that, for those materials that need to be placed at the bottom portion of the heating chamber 1110 for heating and atomization, atomized gas formed by heating and atomization of the organic materials may also be accumulated at the bottom portion of the heating chamber 1110, and the atomized gas accumulated at the bottom portion of the heating chamber 1110 can be disturbed and lifted by an impact of the air flow by blowing the air flow passing through the air inlet 1101 to the inner bottom portion of the heating chamber 1110. The atomized gas lifted in the heating chamber 1110 passes through an air vent 1102 and an air outlet 1103 in the shell 1100 in sequence and then flows out, thus being convenient for a user to suck the atomized gas.

As shown in FIGS. 10, 12, and 17, the shell 1100 is also provided with a hollow tubular air inflow guide member 1130, the air inflow guide member 1130 is provided with a through-hole forming the air inlet 1101, one end of the air inflow guide member 1130 is located in the heating cavity of the heating chamber 1110, and the other end of the air inflow guide member 1130 extends out of the heating cavity of the heating chamber 1110. According to an embodiment of the present disclosure, the other end of the air inflow guide member extends out of the heating cavity and accommodating cavity of the shell 1100 to ambient air. The accommodating cavity of the shell 1100 is the inner cavity of the shell as described herein to house any or all of the material or heating chamber, heating element or heating container, or heating container assembly.

Specifically, the air inflow guide member 1130 may be an air nozzle made of borosilicate glass, and the air nozzle has a hollow interior to form the air inlet 1101. Since the borosilicate glass has a good high temperature resistance, an air outflow end of the borosilicate glass air nozzle may extend into the interior portion of the heating chamber 1110. Meanwhile, an air inflow end of the borosilicate glass air nozzle is communicated with the outside, and when the user sucks the atomized gas, outside air flows in from the air inflow end of the borosilicate glass air nozzle, and flows through the hollow through-hole and the air outflow end of the high borosilicate glass air nozzle to enter the interior portion of the heating chamber 1110, so that the atomized gas accumulated at the bottom portion of the heating chamber 1110 may be disturbed and lifted for the user to suck, thus having a simple structure, being easy to implement, and being beneficial for improving a turbulence effect of an air inflow on the atomized gas at the bottom portion of the heating chamber 1110.

In addition, the claimed invention is not limited in size and may be constructed in various sizes in which the same or similar principles of operation as described above would apply. Furthermore, the figures (and various components shown therein) of the specification are not to be construed as drawn to scale.

The terminology used herein is for the purpose of describing particular example embodiments only and is not intended to be limiting. Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. In other words, unless explicitly stated to the contrary, embodiments “comprising” or “having” an element or a plurality of elements having a particular property can include additional elements not having that property. In other words, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. In other words, the use of “including,” “comprising,” “having,” “containing,” “involving,” and variations thereof, is meant to encompass the items listed thereafter and additional items. Further, references to “one embodiment” or “one implementation” are not intended to be interpreted as excluding the existence of additional embodiments or implementations that also incorporate the recited features. The term “exemplary” is intended to mean “an example of”.

As used herein, the singular forms “a”, “an” and “the” may be intended to include the plural forms as well, unless the context clearly indicates otherwise. In other words, an element or step recited in the singular and preceded by the word “a” or “an” should be understood as not necessarily excluding the plural of the elements or steps. Further, references to “one embodiment” or “one implementation” are not intended to be interpreted as excluding the existence of additional embodiments or implementations that also incorporate the recited features. Thus, when introducing elements of aspects of the disclosure or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” The use of the expression “at least” or “at least one” suggests the use of one or more elements or ingredients or quantities, as the use may be in the embodiment of the disclosure to achieve one or more of the desired objects or results.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary. Any range or value given herein can be extended or altered without losing the effect sought, as will be apparent to the skilled person.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

While various spatial and directional terms, such as “top,” “bottom,” “upper,” “lower,” “vertical,” and the like are used to describe embodiments and implementations of the present disclosure, it is understood that such terms are merely used with respect to the orientations shown in the drawings. The orientations can be inverted, rotated, or otherwise changed, such that a top side becomes a bottom side if the structure is flipped 180 degrees, becomes a left side or a right side if the structure is pivoted 90°, and the like. In other words, spatially relative terms, such as “front,” “rear,” “left,” “right,” “inner,” “outer,” “beneath”, “below”, “lower”, “above”, “upper”, “horizontal”, “vertical”, “lateral”, “longitudinal” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above can relate to one embodiment or can relate to several embodiments. The embodiments are not limited to those that solve any or all of the stated problems or those that have any or all of the stated benefits and advantages. It will further be understood that reference to ‘an’ item refers to one or more of those items.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation (e.g., different steps, etc.) is within the scope of aspects and implementations of the disclosure. In other words, the method steps, processes, and operations described herein are not to be construed as necessarily requiring their performance in the particular order discussed or illustrated, unless specifically identified as an order of performance. It is also to be understood that additional or alternative steps may be employed.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of” “only one of” or “exactly one of ” “Consisting essentially of,” when used in the claims, shall have its ordinary meaning as used in the field of patent law.

As briefly discussed above, as used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are example embodiments. Many other embodiments will be apparent to those of ordinary skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person of ordinary skill in the art to practice the various embodiments of the disclosure, including making and using any devices or systems and performing any incorporated methods. The patentable scope of the various embodiments of the disclosure is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

The above description presents the best mode contemplated for carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above that are fully equivalent. Moreover, features described in connection with one embodiment of the invention may be used in conjunction with other embodiments, even if not explicitly stated above. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

Various technical features of the above embodiments may be combined randomly, and in order to simplify the description, possible combinations of various technical features in the above embodiments are not all described. However, as long as the combinations of these technical features have no contradiction, the combinations of these technical features should be considered as falling into the scope recorded by the specification.

Although the embodiments of the present invention have been shown and described, those of ordinary skills in the art may understand that various changes, modifications, substitutions and variations may be made to these embodiments without departing from the principle and purpose of the present invention, and the scope of the present invention is defined by the claims and their equivalents.

1. An atomization device for three-dimensional heating, the atomization device comprising:
a material chamber having a bottom surface and a sidewall surface;
a heating element having a first segment configured to heat the bottom surface of the material chamber and a second segment configured to heat the sidewall surface of the material chamber;
a first thermo-electrode lead, wherein a first end of the first thermo-electrode lead is connected to a first end of the heating element;
a second thermo-electrode, wherein a first end of the second thermo-electrode lead is connected to a second end of the heating element; and
a shell housing the material chamber, the heating element, the first thermo-electrode lead, and the second thermo-electrode lead.

2. The atomization device for three-dimensional heating of claim 1, further comprising a heating container arranged in the shell, the heating container having a bottom portion and a sidewall portion, wherein the sidewall portion extends from the bottom portion defining a heating cavity and an upper opening, and wherein the heating element is arranged on the bottom portion and the sidewall portion of the heating container.

3. The atomization device for three-dimensional heating of claim 2, wherein both the first end of the first thermo-electrode lead and the first end of the second thermo-electrode lead are arranged on the heating container.

4. The atomization device for three-dimensional heating of claim 3, wherein the heating element, the first thermo-electrode lead, and the second thermo-electrode lead are integrated with the heating container.

5. The atomization device for three-dimensional heating of claim 1, further comprising a marking member, an identification module, and a control module, wherein the marking member is arranged in the shell, the identification module is connected with the marking member to collect electrical parameters of the marking member, and the control module is connected with the identification module to control operation of the heating element according to the electrical parameters.

6. The atomization device for three-dimensional heating of claim 5, wherein the marking member is a resistor.

7. The atomization device for three-dimensional heating of claim 1, further comprising a power supply module and a temperature measurement module, wherein a second end of one of the first thermo-electrode lead or the second thermo-electrode lead is connected with the power supply module and a second end of one of the first thermo-electrode lead or the second thermo-electrode lead is connected with the temperature measurement module.

8. The atomization device for three-dimensional heating of claim 1, wherein the shell further comprises an air inlet communicated with an upper opening of the material chamber, wherein ambient air passing through the air inlet is directed towards a bottom surface of a heating cavity of the material chamber.

9. The atomization device for three-dimensional heating of claim 8, wherein the shell further comprises an air inflow guide member, the air inflow guide member having a through hole forming the air inlet, and wherein one end of the air inflow guide member extends out to ambient air and the other end of the air inflow guide member extends into the material chamber.

10. The atomization device for three-dimensional heating of claim 1, wherein the shell further comprises a heat insulation assembly.

11. A three-dimensional heating atomization device, comprising:
a shell; and
a heating container assembly disposed within the shell, including:
a heating chamber having a bottom wall portion and a sidewall portion, the sidewall portion extending from the bottom wall portion defining an interior cavity and an upper opening; and
a heating element disposed within the sidewall portion and the bottom wall portion of the heating chamber.

12. The three-dimensional heating atomization device of claim 11, wherein the heating container assembly further comprises:
a first thermo-electrode lead, a first end of the first thermo-electrode lead connected to a first end of the heating element; and
a second thermo-electrode lead, a first end of the second thermo-electrode lead connected to a second end of the heating element.

13. The three-dimensional heating atomization device of claim 11, wherein a heat distribution rate of the bottom wall portion of the heating element is greater than a heat distribution rate of the sidewall portion of the heating element.

14. A vaporizer device, comprising:
a three-dimensional heating atomization device further comprising a shell, and a heating container assembly disposed within the shell; wherein the heating container further includes a heating chamber having a bottom wall portion and a sidewall portion, and a heating element disposed within the sidewall portion and the bottom wall portion of the heating chamber; and wherein the sidewall portion extends from the bottom wall portion to define an interior cavity and an upper opening;
a base body housing a power supply, wherein the base body includes an identification portion configured to interface with the three-dimensional heating atomization device; and
a mouthpiece removably attached to the base body.

15. A three-dimensional heating atomization device, comprising:
a shell; and
a heating container assembly disposed within the shell, including:
a heating chamber having a bottom wall portion and a sidewall portion, the sidewall portion extending from the bottom wall portion defining an interior cavity and an upper opening; and
a heating element having a first segment disposed within the sidewall portion of the heating chamber and a second segment disposed within the bottom wall portion of the heating chamber,
wherein the first segment of the heating element has a different resistance than the second segment of the heating element.

16. The three-dimensional heating atomization device of claim 15, wherein the first segment of the heating element has a lower resistance than the second segment of the heating element.

17. The three-dimensional heating atomization device of claim 15, wherein the heating container assembly further comprises:
a first thermo-electrode lead, a first end of the first thermo-electrode lead electro-mechanically connected to a first end of the heating element; and
a second thermo-electrode lead, a first end of the second thermo-electrode lead electro-mechanically connected to a second end of the heating element.

18. The atomization device for three-dimensional heating of claim 2, wherein the material chamber is thermally coupled to the heating element.

19. The atomization device for three-dimensional heating of claim 18, wherein the material chamber is removable.

20. A vaporizer device, comprising:
a three-dimensional heating atomization device further comprising a shell, and a heating container assembly disposed within the shell; wherein the heating container assembly includes a heating chamber having a bottom wall portion and a sidewall portion, and a heating element having a first segment disposed within the sidewall portion of the heating chamber and a second segment disposed within the bottom wall portion of the heating chamber; wherein the first segment of the heating element has a resistance different from a resistance of the second segment of the heating element; and wherein the sidewall portion extends from the bottom wall portion to define an interior cavity and an upper opening;
a base body, the base body including a power supply and a connection port for the three-dimensional heating atomization device; and
a mouthpiece removably attached to the base body.
